(19) United States
(12) Patent Application Publication
(10) Pub. No.: US 2024/0296216 A1
(43) Pub. Date: Sep. 5, 2024

(54) METHODS, SYSTEMS, APPARATUSES, AND COMPUTER PROGRAM PRODUCTS FOR ACCESS PERMISSION CONTROL IN A MOBILE DEVICE

(71) Applicant: Assurant, Inc., New York, NY (US)

(72) Inventors: Brandon JOHNSON, Nashville, TN (US); Harrison HANKS, La Vergne, TN (US); Richa PHULWANI, Nashville, TN (US)

(21) Appl. No.: 18/177,484

(22) Filed: Mar. 2, 2023

(51) Int. Cl. G06F 21/44

(52) U.S. Cl. CPC G06F 21/44; G06F 2221/2145

(57) ABSTRACT

Embodiments of the present disclosure provide methods, apparatuses, and computer program products configured to automatically elevate access permissions of a mobile device. Embodiments include a mobile device access permission elevation system configured for transmitting, to a mobile device, signals configured to simulate a connection of one or more peripheral input devices to the mobile device. Embodiments also include transmitting, to the mobile device, signals configured to simulate a sequence of navigational input commands from the simulated peripheral input devices on the mobile device, where the sequence of navigational input commands is configured to elevate the access permissions of the mobile device to an elevated level. Embodiments also include causing execution of one or more computer executable instructions on the mobile device, where the computer executable instructions require the elevated level of the access permissions.

### TECHNICAL FIELD

Embodiments of the present disclosure are generally directed to mobile device management and, more particularly, to an enterprise-level mobile device access permission elevation system configured to automatically control (e.g., elevate) the access permissions of a mobile device.

### BACKGROUND

Computing devices such as mobile devices including smartphones and tablet computers are now ubiquitous amongst the general public, and new makes and models of mobile devices are released frequently. Managing the reverse-logistics for an enterprise operation dealing with the intake, inspection, refurbishment, and redistribution of mobile devices can be an untenable task requiring an extravagant amount of financial and human resources. Applicant has discovered various technical problems associated with conventional methods, systems, and tools for managing the reverse-logistics of such computing devices. Through applied effort, ingenuity, and innovation, Applicant has solved many of these identified problems by developing the embodiments of the present disclosure, which are described in detail below.

### BRIEF SUMMARY

In one aspect, an apparatus for elevating access permissions of a mobile device includes at least one processor and at least one non-transitory memory including computer-coded instructions thereon. The apparatus includes computer coded instructions that, with the at least one processor, cause the apparatus to transmit, to the mobile device, signals configured to simulate a connection of one or more peripheral input devices to the mobile device. The apparatus also includes computer coded instructions that, with the at least one processor, cause the apparatus to transmit, to the mobile device, signals configured to simulate a sequence of navigational input commands from the simulated peripheral input devices on the mobile device, where the sequence of navigational input commands is configured to elevate the access permissions of the mobile device to an elevated level. The apparatus also includes computer coded instructions that, with the at least one processor, cause execution of one or more computer executable instructions on the mobile device, where the computer executable instructions require the elevated level of the access permissions.

The apparatus further includes where the apparatus comprises one or more cameras. The apparatus also includes computer coded instructions that, with the at least one processor, cause the apparatus to receive image data from the one or more cameras. The apparatus also includes computer coded instructions that, with the at least one processor, cause the apparatus to determine, based on the image data, one or more interface attributes associated with a respective configuration of an electronic interface of the mobile device. The apparatus also includes computer coded instructions that, with the at least one processor, cause the apparatus to determine, based on the one or more interface attributes, a navigational state, where the navigational state is a current location in a mobile device menu hierarchy.

The apparatus further includes computer coded instructions that, with the at least one processor, cause the apparatus to determine, based on the one or more interface attributes, a sequence of navigational input commands. The apparatus also includes computer coded instructions that, with the at least one processor, cause the apparatus to transmit, based on the navigational state, a signal to execute a simulated navigational input command from the sequence of navigational input commands.

The apparatus further includes computer coded instructions that, with the at least one processor, cause the apparatus to determine, based on the image data, a current state of the access permissions associated with the mobile device.

The apparatus further includes where the current state of the access permissions associated with the mobile device is determined by a trained machine vision model.

The apparatus further includes computer coded instructions that, with the at least one processor, cause the apparatus to capture, in response to transmitting the signal to execute the simulated navigational input command of the sequence of navigational input commands, second image data. The apparatus also includes computer coded instructions that, with the at least one processor, cause the apparatus to determine, based on the second image data, a second navigational state of the mobile device.

The apparatus further includes computer coded instructions that, with the at least one processor, cause the apparatus to determine that the second navigational state is a correct navigational state corresponding to a happy-path navigational state.

The apparatus further includes computer coded instructions that, with the at least one processor, cause the apparatus to, prior to causing execution of the one or more software programs on the mobile device, determine whether the access permissions of the mobile device have been elevated.

The apparatus further includes where the one or more software programs executed on the mobile device comprise computer coded instructions configured to execute at least one debugging operation of one or more debugging operations, where the one or more debugging operations comprise instructions to receive device data associated with the mobile device, diagnose one or more faults with the mobile device, repair the one or more faults with the mobile device, and reset the mobile device to a default state.

The apparatus further includes where the signals configured to simulate a sequence of navigational input commands on the mobile device comprise a plurality of simulated keystrokes, and where the signals are transmitted to the mobile device via a cable connected to the mobile device.

In another aspect, a computer-implemented method includes transmitting, to the mobile device, signals configured to simulate a connection of one or more peripheral input devices to the mobile device. The computer-implemented method also includes transmitting, to the mobile device, signals configured to simulate a sequence of navigational input commands from the simulated peripheral input devices on the mobile device, where the sequence of navigational input commands is configured to elevate the access permissions of the mobile device to an elevated level. The computer-implemented method also includes causing execution of one or more computer executable instructions on the mobile device, where the computer executable instructions require the elevated level of the access permissions.

The computer-implemented method further includes where the mobile device access permission elevation system comprises one or more cameras. The computer-implemented method also includes receiving image data from the one or more cameras. The computer-implemented method also includes determining, based on the image data, one or more interface attributes associated with a respective configuration of an electronic interface of the mobile device. The computer-implemented method also includes determining, based on the one or more interface attributes, a navigational state, where the navigational state is a current location in a mobile device menu hierarchy.

The computer-implemented method further includes determining, based on the one or more interface attributes, a sequence of navigational input commands. The computer-implemented method also includes transmitting, based on the navigational state, a signal to execute a simulated navigational input command from the sequence of navigational input commands.

The computer-implemented method further includes determining, based on the image data, a current state of the access permissions associated with the mobile device.

The computer-implemented method further includes where the current state of the access permissions associated with the mobile device is determined by a trained machine vision model.

The computer-implemented method further includes capturing, in response to transmitting the signal to execute the simulated navigational input command of the sequence of navigational input commands, second image data. The computer-implemented method also includes determining, based on the second image data, a second navigational state of the mobile device.

The computer-implemented method further includes determining that the second navigational state is a correct navigational state corresponding to a happy-path navigational state.

The computer-implemented method further includes, prior to causing execution of the one or more software programs on the mobile device, determining whether the access permissions of the mobile device have been elevated.

The computer-implemented method further includes where the one or more software programs executed on the mobile device comprise computer coded instructions configured to execute at least one debugging operation of one or more debugging operations, where the one or more debugging operations comprise instructions for receiving device data associated with the mobile device, diagnosing one or more faults with the mobile device, repairing the one or more faults with the mobile device, and resetting the mobile device to a default state.

The computer-implemented method further includes where the signals configured to simulate a sequence of navigational input commands on the mobile device comprise a plurality of simulated keystrokes, and where the signals are transmitted to the mobile device via a cable connected to the mobile device.

In yet another aspect, computer program product for elevating access permissions of a mobile device includes at least one non-transitory computer-readable storage medium having computer program code stored thereon, and at least one processor. The computer program product includes computer program code that, with the at least one processor, cause the computer program product to transmit, to the mobile device, signals configured to simulate a connection of one or more peripheral input devices to the mobile device. The computer program product also includes computer program code that, with the at least one processor, cause the computer program product to transmit, to the mobile device, signals configured to simulate a sequence of navigational input commands from the simulated peripheral input devices on the mobile device, where the sequence of navigational input commands is configured to elevate the access permissions of the mobile device to an elevated level. The computer program product also includes computer program code that, with the at least one processor, cause execution of one or more computer executable instructions on the mobile device, where the computer executable instructions require the elevated level of the access permissions.

The computer program product further includes one or more cameras. The computer program product also includes computer program code that, with the at least one processor, cause the computer program product to receive image data from the one or more cameras. The computer program product also includes computer program code that, with the at least one processor, cause the computer program product to determine, based on the image data, one or more interface attributes associated with a respective configuration of an electronic interface of the mobile device.

The computer program product also includes computer program code that, with the at least one processor, cause the computer program product to determine, based on the one or more interface attributes, a navigational state, where the navigational state is a current location in a mobile device menu hierarchy.

The computer program product further includes computer program code that, with the at least one processor, cause the computer program product to determine, based on the one or more interface attributes, a sequence of navigational input commands. The computer program product also includes computer program code that, with the at least one processor, cause the computer program product to transmit, based on the navigational state, a signal to execute a simulated navigational input command from the sequence of navigational input commands.

The computer program product further includes computer program code that, with the at least one processor, cause the computer program product to determine, based on the image data, a current state of the access permissions associated with the mobile device.

The computer program product further includes where the current state of the access permissions associated with the mobile device is determined by a trained machine vision model.

The computer program product further includes computer program code that, with the at least one processor, cause the computer program product to capture, in response to transmitting the signal to execute the simulated navigational input command of the sequence of navigational input commands, second image data. The computer program product also includes computer program code that, with the at least one processor, cause the computer program product to determine, based on the second image data, a second navigational state of the mobile device.

The computer program product further includes computer program code that, with the at least one processor, cause the computer program product to determine that the second navigational state is a correct navigational state corresponding to a happy-path navigational state.

The computer program product further includes computer program code that, with the at least one processor, cause the computer program product to, prior to causing execution of the one or more software programs on the mobile device, determine whether the access permissions of the mobile device have been elevated.

The computer program product further includes where the one or more software programs executed on the mobile device comprise computer coded instructions configured to execute at least one debugging operation of one or more debugging operations, where the one or more debugging operations comprise instructions to receive device data associated with the mobile device, diagnose one or more faults with the mobile device, repair the one or more faults with the mobile device, and reset the mobile device to a default state.

The computer program product further includes where the signals configured to simulate a sequence of navigational input commands on the mobile device comprise a plurality of simulated keystrokes, and where the signals are transmitted to the mobile device via a cable connected to the mobile device.

### BRIEF DESCRIPTION OF THE SEVERAL VIEWS OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein. To easily identify the discussion of any particular element or act, the most significant digit or digits in a reference number refer to the figure number in which that element is first introduced.

FIG. 1 is a diagram of an exemplary environment configured for automatically elevating access permissions in a mobile device in accordance with one or more embodiments of the present disclosure.

FIG. 2 is a block diagram of an exemplary computing device structured in accordance with one or more embodiments of the present disclosure.

FIG. 3 is a block diagram illustrating various data flows between components comprised within a mobile device access permission elevation system in an exemplary environment configured for automatically elevating access permissions in a mobile device in accordance with one or more embodiments of the present disclosure.

FIG. 4A-4B illustrate a plurality of exemplary mobile devices depicting various configurations of interface attributes on the respective electronic interfaces of the mobile devices in accordance with one or more embodiments of the present disclosure.

FIG. 5 illustrates an exemplary environment 500 comprising a grid of regions-of-interest comprising respective mobile devices staged for access permissions elevation processing in accordance with one or more embodiments of the present disclosure.

FIG. 6 illustrates a flowchart representing a process 600 for transmitting signals to simulate navigational input commands on a mobile device to elevate access permissions associated with the mobile device in accordance with one or more embodiments of the present disclosure.

FIG. 7 illustrates a flowchart representing a process 700 for using image data to automatically elevate access permissions in a mobile device in accordance with one or more embodiments of the present disclosure.

FIG. 8 illustrates a flowchart representing a process 800 for using image data to automatically elevate access permissions and cause execution of one or more computer executable instructions on a mobile device in accordance with one or more embodiments of the present disclosure.

### DETAILED DESCRIPTION

Various embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. The terms “illustrative,” “example,” and “exemplary” are used to be examples with no indication of quality level or preference. Like numbers refer to like elements throughout.

### Overview

One of the biggest challenges for enterprises that deal in the reverse-logistics of mobile devices is that one or more particular makes, models, operating systems, firmware versions, carrier information, and/or other identifying information of mobile device could potentially have at least partially different software and hardware, including details related to the mobile device's internal menus, data structures, and access permissions. Before an enterprise can use or interact with a mobile device via electronic commands (e.g., to refurbish and redistribute a mobile device), an enterprise computing system must gain administrative access to the mobile device in order to execute various software applications and functions, such as for inspecting, diagnosing, and/or reformatting the mobile device back into a default configuration based on the original factory settings. To gain such access to a mobile device may require a particular unlocking action involving navigating one or more commands of the mobile device, which may be unique to a particular device or subset of devices. For example, each mobile operating system may have a unique process for obtaining electronic access to the device for executing various functions thereon. Similarly, different phone manufacturers and different models and/or generations of phones may have unique processes for obtaining electronic access to the device for executing various functions thereon. In a high-volume reverse-logistics environment, correctly identifying the algorithm to gain access to the device and navigating each unique mobile device in order to control access permissions (e.g., place the mobile device into an administrative, or “debugging,” mode) is a tedious and inefficient task.

Embodiments of the present disclosure automate the process of elevating the access permissions associated with a mobile device, including to put the mobile device into an administrative mode such that one or more computer executable instructions (e.g., software programs) may be run on the mobile device. Because various makes, models, operating systems, firmware versions, carrier information, and/or other identifying information associated with mobile devices may have different means of entering an administrative mode, some methods often prohibit automated methods of interaction with the mobile device and/or require unreliable technical solutions such as near-field communication (NFC) readers and/or quick response (QR) codes and particular software executed by the mobile device to elevate the access permissions on the mobile device. Furthermore, for methods that rely on NFC and/or QR codes, a user must manually set up the mobile device such that the user can employ the NFC reader and/or the camera integrated with the mobile device to scan a QR code. In this regard, Applicant has addressed these and other technical problems by inventing methods, systems, and apparatuses capable of automatically elevating the access permissions of a mobile device without requiring, although not precluding in all situations, any prior manual electronic operation of the mobile device.

Embodiments of the present disclosure comprise a mobile device access permission elevation system capable of directly interfacing with a mobile device. The mobile device access permission elevation system may include one or more computing devices, one or more cameras, one or more data stores, and a networking environment. In some embodiments, the mobile device access permission elevation system can transmit signals configured to simulate a connection of one or more peripheral input devices to the mobile device. For example, the mobile device access permission elevation system can simulate the connection of a computer keyboard and/or a computer mouse to the mobile device. Once a simulated connection of the one or more peripheral devices has been established, the mobile device access permission elevation system can then transmit signals configured to simulate a sequence of navigational input commands directed toward elevating the access permissions of the mobile device. For example, the access permission elevation system can transmit signals that simulate computer keyboard entries, touch inputs, computer mouse clicks, and/or the like and thereby navigate a mobile device menu hierarchy associated with the mobile device to control one or more functions of the mobile device. Once the access permissions of the mobile device have been elevated to an administrative level, the mobile device access permission elevation system can cause execution of one or more computer executable instructions on the mobile device. In various embodiments, the one or more computer executable instructions executed on the mobile device are directed towards retrieving, altering, and/or removing data stored in the non-transitory memory of the mobile device, diagnosing and/or repairing one or more faults, elevating and/or demoting various access permissions, and/or re-instantiating default factory settings associated with the mobile device.

Embodiments of the present disclosure can employ a machine vision model to analyze the mobile device (e.g., by imaging the screen), which may ensure that a correct sequence of navigational input commands has been executed on the mobile device and can confirm that the access permissions associated with the mobile device have been elevated to an administrative level. For this purpose, one or more cameras associated with the mobile device access permission elevation system can be oriented towards the electronic interface of the mobile device and can capture image data related to the configuration of various interface attributes rendered on the electronic interface. In some embodiments, interface attributes can include, but are not limited to, a text label, a menu, a color, a notification, an interactive icon, a button, a hyperlink, an image, and/or a custom control associated with the mobile device, including combinations and arrangements thereof. In some embodiments, the interface attributes associated with the electronic interface can be visual representations of mobile device attributes related to the mobile device, such as, for example, the mobile device's makes, models, operating systems, firmware versions, carrier information, and/or other identifying information, which may explicitly or implicitly suggest such attributes (e.g., explicitly via text on a screen, implicitly via unique styling, shape, etc., and/or similar qualities). Based on the captured image data, the machine vision model (e.g., a trained computational neural network) associated with the mobile device access permission elevation system can determine an appropriate sequence of navigational input commands to be executed.

The machine vision model associated with the mobile device access permission elevation system can also determine, based on the image data, a navigational state of the mobile device, where the navigational state is a current location in the mobile device menu hierarchy associated with the mobile device. The machine vision model and image data may complete a feedback loop with the simulated peripheral input device(s) to inform the inputs to be applied and/or the effectiveness of one or more inputs. For example, based on the current navigational state of the mobile device as determined, in some embodiments, by the machine vision model, the mobile device access permission elevation system can determine a next navigational input command of the sequence of navigational input commands to execute. In various embodiments, the mobile device access permission elevation system can capture image data (e.g., still images and/or video) during each step of the sequence of navigational input commands and store said image data in a data store. Additionally, the mobile device access permission elevation system can associate the captured image data with one or more respective navigational input commands and/or states. In various embodiments, the mobile device access permission elevation system can employ, amongst other data, the image data stored in the data store to iteratively train and/or update the machine vision model such that the accuracy and efficiency of the machine vision model is consistently improving the more it is employed and the more types of mobile devices it processes.

Embodiments of the present disclosure offer myriad technical advantages for the reverse-logistics industry. Embodiments of the present disclosure greatly reduce the time and resources necessary to elevate the access permissions in a mobile device such that one or more computer executable instructions (e.g., software programs) can be executed to retrieve, alter, and/or remove data stored in the non-transitory memory of the mobile device, diagnose and/or repairing one or more faults, elevate and/or demote various access permissions, and/or re-instantiate default factory settings associated with the mobile device. It will be appreciated that the mobile device access permission elevation system itself is improved over time as the associated machine vision model becomes more accurate and efficient over time.

### Definitions

The term “mobile device access permission elevation system” refers to a system that may include one or more computing devices, one or more cameras, one or more data stores, computer-coded instructions, executable code, and/or a software application that is configured for execution via the one or more computing devices. The computing devices and the computing devices' associated components may facilitate the configuration and management of a mobile device. In one or more embodiments, the mobile device access permission elevation system comprises one or more computing devices, one or more cameras, and/or one or more data stores, and the mobile device access permission elevation system can communicate with one or more networks. The mobile device access permission elevation system is capable of interfacing with one or more mobile devices such that the mobile device access permission elevation system can elevate the access permission level associated with the one or more mobile devices. The mobile device access permission elevation system can transmit (e.g., via a USB connection) signals configured to simulate a connection of one or more peripheral devices to the mobile device. Furthermore, the mobile device access permission elevation system can transmit signals configured to simulate a sequence of navigational input commands on the mobile device, where the sequence of navigational input commands elevates the access permissions of the mobile device. Once the mobile device access permission elevation system has successfully elevated the access permissions of the mobile device to an administrative level (e.g., into a debug mode), the mobile device access permission elevation system can cause execution of one or more computer executable instructions on the mobile device. In various embodiments, the mobile device access permission elevation system can reformat the mobile device and reset the mobile device back to a default state based on factory settings. In various embodiments, the mobile device access permission elevation system can be configured to execute any function of the mobile device. In one or more embodiments, the mobile device access permission elevation system employs a trained machine vision model configured in order to verify the navigational input command sequence is being correctly administered to elevate the access permissions of the mobile device.

The term “mobile device menu hierarchy” refers to an electronically managed organizational data structure of a mobile device. The mobile device menu hierarchy may include a representation of all the data, menus, and/or applications comprised within the mobile device. In various embodiments, the mobile device menu hierarchy may comprise interactive menus and sub-menus related to the various configuration parameters associated with the mobile device such that a mobile device access permission elevation system may navigate through said menus and sub-menus in order to update the configurations and access permissions related to the mobile device. Each location (e.g., level, sub-level, and/or node) within the mobile device menu hierarchy is associated with a specific configuration of interface attributes, or “navigational states,” associated with the mobile device. In various embodiments, the mobile device menu hierarchy and related navigational states are unique to one or more particular makes, models, operating systems, firmware versions, carrier information, and/or other identifying information of a particular mobile device.

The term “interface attribute” refers to any renderable feature associated with a mobile device. Non-limiting examples of an interface attribute include a text label, a menu, a color, a notification, an interactive icon, a button, a hyperlink, an image, and/or a custom control displayed on an interface of a mobile device. In various embodiments, an interface attribute may be a visual representation of one or more mobile device attributes or may be indicative of one or more mobile device attributes.

The term “mobile device attribute” refers to any data related to a mobile device, including, but not limited to, a mobile device manufacturer, a mobile device model, a mobile device operating system, a mobile device software version, a current access permission level, a combination thereof, and/or similar attributes.

The term “navigational state” refers to a specific configuration of interface attributes rendered on the display of a mobile device representing a current location within the mobile device menu hierarchy associated with the mobile device. For example, a navigational state of a mobile device may comprise a state associated with a settings menu in an instance in which the device is currently displaying the settings menu.

The term “navigational input command” refers to an input command issued to a mobile device or configured to be issued to a mobile device. In some embodiments, the navigational input command may be configured to navigate the mobile device to a different location within the mobile device menu hierarchy thereby causing the mobile device to enter into a different navigational state. Navigational input commands may be commands associated with one or more peripheral input devices such as, but not limited to, computer keyboard entries, computer mouse interactions, touchscreen/touchpad entries, microphone input, touchpad interactions, trackball interactions, and/or other inputs, whether electronically simulated or generated by physical corresponding input devices. In some embodiments, navigational input commands comprise input commands, whether simulated or real, associated with a human interaction with an electronic interface of the mobile device such as, but not limited to, a finger press on the electronic interface, a combination of multiple, simultaneous finger presses on the electronic interface, a sequence of finger presses on the electronic interface, and a swipe along the electronic interface. In some embodiments, navigational input commands comprise input commands, whether simulated or real, associated with a human interaction with one or more physical buttons integrated with the mobile device such as, but not limited to, a press of the one or more physical buttons, and a combination of simultaneous presses of the one or more physical buttons.

The term “navigational input command sequence” refers to a sequence of navigational input commands. In some embodiments, a navigational input command sequence may be directed towards elevating the access permission level of a mobile device. In various embodiments, the navigational input command sequence must be executed in strict order for the access permissions to be elevated. In some embodiments, the navigational input command sequence is a collection of navigational input commands whose order is determined by the one or more navigational states associated with the mobile device in order to elevate the access permission level of the mobile device.

The term “simulating a navigational input command”, “simulated navigational input command”, or similar terms refer to a portion of executable code configured to simulate a user-initiated navigational input command. In some embodiments, such terms may relate to executable code employed by a mobile device access permission elevation system on a mobile device. The simulated navigational input commands are associated with a simulated connection of a peripheral device to the mobile device. Non-limiting examples of a simulated navigational input command include, but are not limited to, simulated keyboard entries, simulated computer mouse interactions, simulated microphone input, simulated touchpad interactions, and simulated trackball interactions. Additionally, the simulated navigational input commands can be associated with simulated human interaction with the electronic interface of the mobile device. Non-limiting examples of this type of simulated navigational input commands include a simulated finger press on the electronic interface, a simulated combination of multiple, simultaneous finger presses on the electronic interface, a simulated sequence of finger presses on the electronic interface, a simulated swipe along the electronic interface, a simulated press of one or more physical buttons integrated with the mobile device, and a simulated combination of simultaneous presses of the one or more physical buttons.

The term “peripheral input device” refers to one or more input devices, whether such devices are physical devices or electronically simulated to give the appearance of a physical device to a mobile device. One or more peripheral input devices may be employed in the connection to the mobile device, whether such connection is via physical connector (e.g., physical connector of a physical input device and/or physical connector associated with the computing device which simulates an input device over the physical connector) or otherwise. Non-limiting examples of peripheral input devices include computer keyboards, computer mice, microphones, joysticks, touchpads, trackballs, and any other peripheral input devices capable of manipulating the mobile device.

The term “access permissions” refers to a set of rules defining the authorization to access specific resources, data, files, applications, configuration parameters, and/or networks associated, for example, in association with a mobile device. In some embodiments, access permissions may be user agnostic (e.g., debug mode may not depend on the identity or credentials of a particular user). In some embodiments, access permissions may be user-specific.

The term “access permission level” refers to the current access permissions granted for a mobile device. Depending on the access permission level, access to various specific resources, data, files, applications, configuration parameters, and/or networks may be enabled or disabled. In some embodiments, a particular access permission level may allow the user of the mobile device to view and/or interact with the various resources and data comprised on the mobile device without allowing the user to add, modify, and/or delete said resources and data. In some embodiments, a debug mode may correspond to an access permission level configured to permit the execution of one or more computer executable instructions on the mobile device.

The term “trained machine vision model” refers to an algorithmic, statistical, and/or machine learning model that can detect, extract, and/or otherwise derive particular data from image data. Non-limiting examples of a trained machine vision model include a trained neural network, a trained machine learning model, a trained artificial intelligence, and/or at least one image process algorithm. In various embodiments, the trained machine vision model is trained using image data captured by one or more cameras associated with the mobile device access permission elevation system. Said image data can include, but is not limited to, image data related to one or more mobile device attributes, one or more interface attributes, one or more navigational states, and/or data related to the mobile device menu hierarchy of a particular mobile device. In some embodiments, the image data captured by the mobile device access permission elevation system is associated with one or more navigational states and/or one or more navigational input commands of the navigational input command sequence.

As used herein, the terms “data,” “content,” “digital content,” “digital content object,” “information,” and similar terms may be used interchangeably to refer to data capable of being transmitted, received, created, modified, and/or stored in accordance with examples of the present disclosure. Thus, use of any such terms should not be taken to limit the spirit and scope of examples of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like (sometimes referred to herein as a “network”). Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “circuitry” should be understood broadly to include hardware and, in some examples, software for configuring the hardware. With respect to components of the apparatus, the term “circuitry” as used herein should therefore be understood to include particular hardware configured to perform the functions associated with the particular circuitry as described herein. For example, in some examples, “circuitry” may include processing circuitry, storage media, network interfaces, input/output devices, and the like.

“Executable code” refers to a portion of computer program code storable and/or stored in one or a plurality of locations that is executed and/or executable via one or more computing devices embodied in hardware, software, firmware, and/or any combination thereof. Executable code may define at least one particular operation to be executed by one or more computing devices.

In some embodiments, a memory, storage, and/or other computing device includes and/or otherwise is structured to define any amount of executable code (e.g., a portion of executable code associated with a first operation and a portion of executable code associated with a second operation). Alternatively or additionally, in some embodiments, executable code is embodied by separate computing devices (e.g., a first data store embodying first portion of executable code and a second data store embodying a second portion executable code).

“Data store” refers to any type of non-transitory computer-readable storage medium. Non-limiting examples of a data store include hardware, software, firmware, and/or a combination thereof capable of storing, recording, updating, retrieving and/or deleting computer-readable data and information, whether embodied locally and/or remotely and whether embodied by a single hardware device and/or a plurality of hardware devices.

“Data attribute” refers to electronically managed data representing a variable, a particular criteria, or a property having a particular value or status. The value may be statically fixed or dynamically assigned. In some embodiments, a data attribute embodies a particular property of a data object.

“Data value” refers to electronically managed data representing a particular value associated with a particular data attribute.

“Data object” refers to an electronically managed data structure representing a collection of one or more data attributes and/or portions of executable code

The term “computing device” refers to any computer, processor, circuitry, and/or other executor of computer instructions that is embodied in hardware, software, firmware, and/or any combination thereof, that enables access to myriad functionalities associated with one or more mobile device(s), system(s), and/or one or more communications networks. Non-limiting examples of a computing device include a computer, a processor, an application-specific integrated circuit, a field-programmable gate array, a personal computer, a smart phone, a laptop, a fixed terminal, a server, a networking device, and a virtual machine.

The term “mobile device” refers to any portable computing device, such as, but not limited to, a portable digital assistant (PDA), mobile telephone, smartphone, or tablet computer with one or more communications, networking, and/or interfacing capabilities. Non-limiting examples of communications, networking, and/or interfacing capabilities include CDMA, TDMA, 4G, 5G, NFC, Wi-Fi, Bluetooth, as well as hard-wired connection interfaces such as USB, Thunderbolt, and/or ethernet connections.

### Example Systems and Apparatuses of the Disclosure

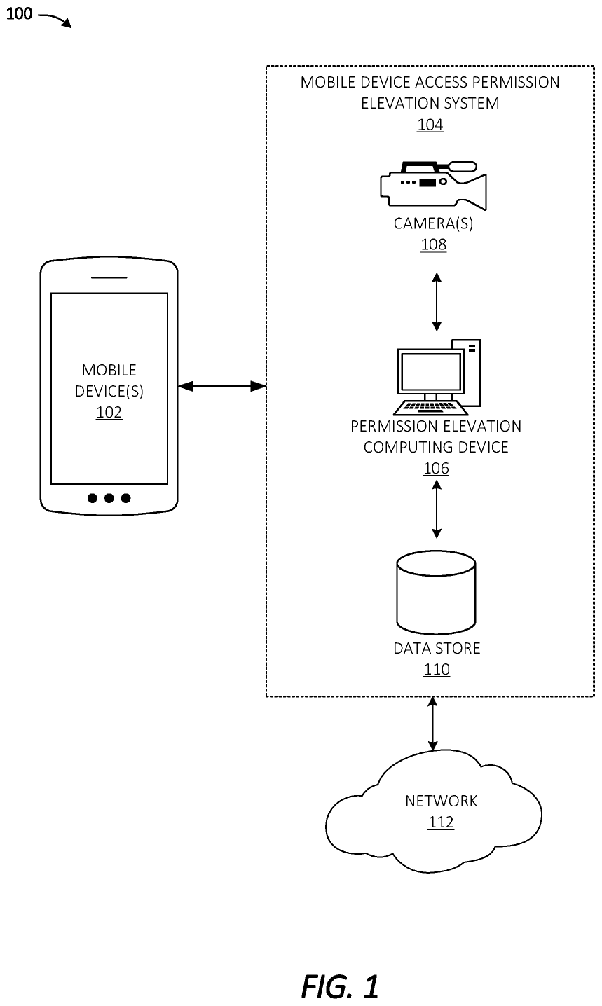

FIG. 1 illustrates an exemplary environment 100 configured for controlling (e.g., elevating) access permissions in a mobile device in accordance with one or more embodiments of the present disclosure. The exemplary environment 100 includes a mobile device access permission elevation system 104 capable of directly interfacing with one or more mobile device(s) 102. In one or more embodiments, a mobile device can be any portable computing device, such as, but not limited to, a portable digital assistant (PDA), mobile telephone, smartphone, or tablet computer with one or more communications, networking, and interfacing capabilities. Non-limiting examples of communications, networking, and interfacing capabilities include CDMA, TDMA, 4G, 5G, NFC, Wi-Fi, Bluetooth, as well as hard-wired connection interfaces such as USB, Thunderbolt, and/or ethernet connections. For example, non-limiting examples of mobile device(s) 102 can include Galaxy S21 model smartphones manufactured by Samsung® and running the Android 12 operating system. One of the many technical benefits presented by some embodiments of the present disclosure is the manufacturer-agnostic nature of the mobile device access permission elevation system 104, which may be trained to interact with any of a plurality of different devices (e.g., different makes, models, operating systems, firmware, etc.). For instance, some embodiments can integrate with, but are not limited to, mobile devices produced by Google®, Sony®, Motorola®, Samsung®, Amazon®, HTC®, and more.

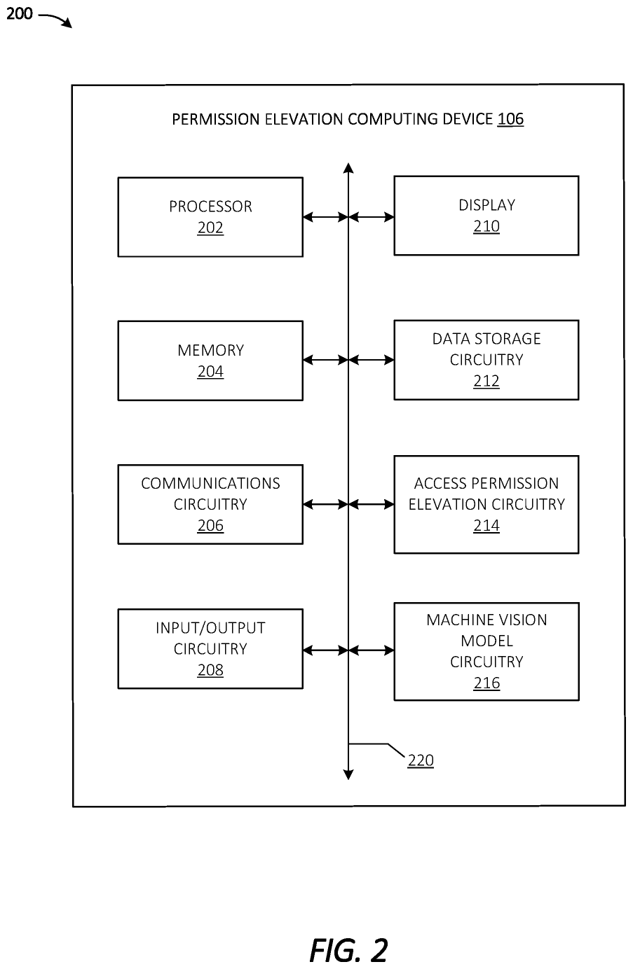

The depicted embodiment of the mobile device access permission elevation system 104 also comprises an access permission elevation computing device 106 (described herein below and in FIG. 2 in greater detail, also referred to as just “computing device”) configured to transmit signals and execute various portions of executable code related to elevating the access permissions of mobile device(s) 102. For example, the access permission elevation computing device 106 of the mobile device access permission elevation system 104 can transmit (e.g., via a USB connection) signals configured to simulate a connection of one or more peripheral devices to the mobile device(s) 102. Furthermore, the access permission elevation computing device 106 of the mobile device access permission elevation system 104 can transmit signals configured to simulate a sequence of navigational input commands on the mobile device(s) 102 (e.g., commands interpreted by the mobile device as having been received by the one or more peripheral devices), where the sequence of navigational input commands elevates the access permissions of the mobile device(s) 102. Once the mobile device access permission elevation system 104 has successfully elevated the access permissions of the mobile device(s) 102 to an administrative level, the access permission elevation computing device 106 can cause execution of one or more software programs on the mobile device(s) 102. In various embodiments, the access permission elevation computing device 106 of the mobile device access permission elevation system 104 can reformat the mobile device(s) 102 and reset the mobile device(s) 102 back to a default state based on factory settings.

Additionally or alternatively, the mobile device access permission elevation system 104 can establish one or more types of wireless networking connection with the one or more peripheral devices to the mobile device(s) 102 in order to transmit the one or more signals. For example, the mobile device access permission elevation system 104 can establish a wireless networking connection (Wi-Fi) such as a local area network (LAN) connection, a Wide Area Network (WAN) connection, a personal area network (PAN) connection, a short-range wireless network (e.g., a Bluetooth® network), and/or the like with the mobile device(s) 102. The wireless connection may be used, for example, to transmit data and/or computer executable instructions to and from the mobile device(s) 102.

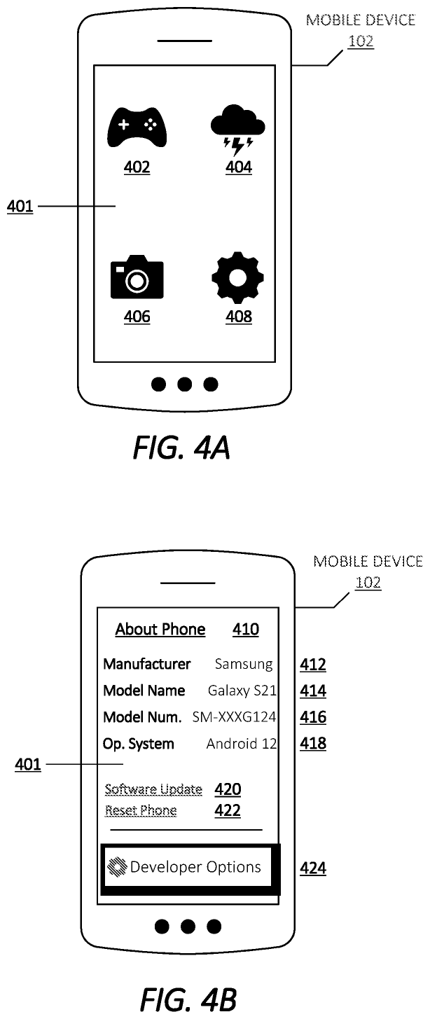

The depicted embodiment of the mobile device access permission elevation system 104 also comprises one or more camera(s) 108 used in accordance with various embodiments of the present disclosure. In one or more embodiments, the mobile device access permission elevation system 104 employs the camera(s) 108 in conjunction with a trained machine vision model acting on image data captured by the camera(s). In some embodiments, the mobile device access permission elevation system 104 is configured to verify that a navigational input command sequence is being correctly administered to elevate the access permissions of the mobile device(s) 102 and/or to determine the navigational state(s) of the mobile device at any given time. The mobile device access permission elevation system 104 may thereby determine various states and attributes of the mobile device, such as verifying a current or correct access permission level, the effectiveness of one or more navigational input commands, identification of a current navigational state of the mobile device, identification of the mobile device and/or one or more aspects thereof (e.g., an operating system, firmware version, etc.), and/or the like. Additionally, any image data captured by the camera(s) 108 can be automatically stored in the data store 110 and additionally or alternatively later used by the trained machine vision model for further training and refinement such that the accuracy and efficiency of the trained machine vision model can be iteratively improved. In various embodiments, the camera(s) 108 can be configured to capture image data related to the electronic interface (e.g., electronic interface 401 shown in FIG. 4) of the mobile device(s) 102 for the entire execution of the navigational input command sequence. Alternatively, the camera(s) 108 can be configured to capture only snapshots of the electronic interface 401 of the mobile device(s) 102 for one or more respective navigational input command in the sequence of navigational input commands and/or one or more interface attributes independent of, prior to, and/or following entry of one or more navigational input commands. In various embodiments, the mobile device access permission elevation system 104 may be configured to capture and process image data related to the physical structure of the mobile device(s) 102 (e.g., a shape, size, color, camera placement, etc.), which may, for example, permit the model to analyze the device type (e.g., make and model), in addition to or instead of capturing and processing image data related to an electronic interface (e.g., the GUI of the mobile device).

In various embodiments, the one or more camera(s) 108 in the mobile device access permission elevation system 104 can be any one or more of, but are not limited to, a pan-tilt-zoom (PTZ) camera, a digital SLR, a webcam, a video camera, and/or the like. In various embodiments, the camera(s) 108 are oriented towards the mobile device(s) 102 such that the electronic interface (e.g., electronic interface 401) of the mobile device(s) 102 is directly in view. In some embodiments, the camera(s) 108 may be mounted to a frame structure that supports the camera(s) over the mobile device(s). In other embodiments, the camera(s) 108 are mounted on tripods, boom stands, and/or the like such that the positions and viewing angles of the camera(s) 108 can be freely adjusted to best capture the electronic interface 401 of the mobile device(s) 102. In some embodiments, various filters are affixed to the lenses of the camera(s) 108 in order to best capture the electronic interface 401 of the mobile device(s) 102. In some embodiments, the access permission elevation computing device 106 of the mobile device access permission elevation system 104 can control various functionalities of the camera(s) 108 including, but not limited to, the exposure, frame rate, aperture, contrast, coloring, and the like as well as any lighting fixtures connected to the camera(s) 108. In some embodiments, a single camera may be configured to capture multiple mobile devices within its field of view. In such embodiments, the trained machine vision model may be configured to separately analyze a plurality of regions of interest of the captured image data, with different regions of interest being associated with different mobile devices. In some embodiments, a single camera may capture a plurality of regions of interest, and the regions may be subdivided in software on the computing device. In some embodiments, different cameras may capture one or more different regions of interest, and the image data from the respective cameras may be associated with the region(s) of interest towards which they are oriented.

The depicted mobile device access permission elevation system 104 also comprises a data store 110 used in accordance with various embodiments of the present disclosure. The data store 110 can be any configuration of non-transitory computer-readable storage medium. Non-limiting examples of a data store include hardware, software, firmware, and/or a combination thereof capable of storing, recording, updating, retrieving and/or deleting computer-readable data and information. For example, the data store 110 can contain one or more navigational input command sequences to be executed by the access permission elevation computing device 106 on the mobile device(s) 102 in order to elevate the access permissions of the mobile device(s) 102. In some embodiments, the memory incorporated with the access permission elevation computing device 106 (e.g., memory 204) comprises the one or more navigational input command sequences to be executed on the mobile device(s) 102. Additionally or alternatively, the data store 110 may be used to store, update, and maintain the image data captured by the camera(s) 108. In various embodiments, the access permission elevation computing device 106 can direct the data store 110 to retrieve and/or transmit data via the network 112. For instance, the access permission elevation computing device 106 can direct the data store 110 to transmit image data captured by the camera(s) 108 via the network 112 to a second reverse-logistics depot associated with an enterprise employing the mobile device access permission elevation system 104 such that the second reverse-logistics depot can train a second machine vision model. In some embodiments, the access permission elevation computing device 106 can be configured to facilitate the retrieval of image data and/or data related to one or more navigation input command sequences via the network 112 for subsequent storage in the data store 110. In some embodiments, the data store 110 may house some or all of the trained machine vision model for retrieval by the computing device. In various embodiments, any data and/or executable code used in or useful for any of the embodiments discussed herein may be stored on the data store 110. Hardware suitable for use as part of a data store include all forms of non-volatile memory, media and memory devices, including by way of example, and without limitation, semiconductor memory devices, e.g., EPROM, EEPROM, and flash memory devices; magnetic disks, e.g., internal hard disks or removable disks; magneto-optical disks; and CD-ROM and DVD-ROM disks.

In various embodiments, the network 112 integrated with the mobile device access permission elevation system 104 is any suitable network or combination of networks and supports any appropriate protocol suitable for communication of data to and from components of the mobile device access permission elevation system 104. In some embodiments, the network(s) 112 may connect the mobile device access permission elevation system 104 with one or more external computing devices, including, but not limited to, one or more mobile devices. In some embodiments, the network(s) 112 may connect one or more portions of the mobile device access permission elevation system 104 with one or more other portions of the mobile device access permission elevation system 104. According to various embodiments, network 112 may include a public network (e.g., the Internet), a private network (e.g., a network within an organization), or a combination of public and/or private networks. According to various embodiments, network 112 is configured to provide communication between various components depicted in FIG. 1 (e.g., access permission elevation computing device 106 and/or data store 110). According to various embodiments, network 112 can comprise one or more networks that connect devices and/or components in the network layout to allow communication between the devices and/or components. For example, the network 112 can be implemented as the Internet, a wireless network, a wired network (e.g., Ethernet), a local area network (LAN), a Wide Area Network (WANs), Bluetooth, Near Field Communication (NFC), Worldwide Interoperability for Microwave Access (WiMAX) network, a personal area network (PAN), a short-range wireless network (e.g., a Bluetooth® network), an infrared wireless (e.g., IrDA) network, an ultra-wideband (UWB) network, an induction wireless transmission network, and/or any other type of network that provides communications between one or more components of the network layout. In some embodiments, network 112 is implemented using cellular networks, satellite, licensed radio, or a combination of cellular, satellite, licensed radio, and/or unlicensed radio networks. In one or more embodiments, the communications circuitry 206 comprised in the access permission elevation computing device 106 can transmit and receive data objects to and from the mobile device access permission elevation system 104 via the network 112.

FIG. 2 illustrates a block diagram 200 of an example apparatus according to one or more described features of one or more embodiments of the disclosure. The block diagram 200 may represent an access permission elevation computing device 106 to facilitate elevating the access permissions of a mobile device in accordance with at least some example embodiments of the present disclosure. In some embodiments, the mobile device access permission elevation system 104 can be integrated with, or embodied by, one or more devices such as the access permission elevation computing device 106 as depicted and described in FIG. 2. The access permission elevation computing device 106 may include a processor 202, memory 204, communications circuitry 206, input/output circuitry 208, display 210, data storage circuitry 212, access permission elevation circuitry 214, and/or machine vision model circuitry 216 that are in electronic communication with one another via a system bus 220. In some embodiments, system bus 220 refers to a computer bus that connects these components so as to enable data transfer and communications between these components. Additionally, or alternatively, the access permission elevation computing device 106 may be in other form(s) and/or may comprise other component(s).

In general, the terms computing device, system, entity, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the access permission elevation computing device 106 embodies a particular, specially configured computing system transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. In some embodiments, other elements of the access permission elevation computing device 106 provide or supplement the functionality of another particular set of circuitry. For example, the processor 202 in some embodiments provides processing functionality to any of the sets of circuitry, the memory 204 provides storage functionality to any of the sets of circuitry, the communications circuitry 206 provides network interface functionality to any of the sets of circuitry, and/or the like.

The processor 202 may be embodied in a number of different ways and may, for example, include one or more processing devices configured to perform independently. Additionally, or alternatively, the processor 202 may include one or more processors configured in tandem via a bus to enable independent execution of instructions, pipelining, and/or multithreading. Additionally, in some embodiments, the processor 202 may include one or processors, some which may be referred to as sub-processors, to control one or more components, modules, or circuitry of access permission elevation computing device 106.

The processor 202 may be embodied as one or more complex programmable logic devices (CPLDs), microprocessors, multi-core processors, co-processing entities, application-specific instruction-set processors (ASIPs), and/or controllers. Further, the processor 202 may be embodied as one or more other processing devices or circuitry. The term circuitry may refer to a hardware embodiment or a combination of hardware and computer program products. Thus, the processor 202 may be embodied as integrated circuits, application specific integrated circuits (ASICs), field programmable gate arrays (FPGAs), programmable logic arrays (PLAs), hardware accelerators, another circuitry, and/or the like. As will therefore be understood, the processor 202 may be configured for a particular use or configured to execute instructions stored in volatile or non-volatile media or otherwise accessible to the processor 202. As such, whether configured by hardware or computer program products, or by a combination thereof, the processor 202 may be capable of performing steps or operations according to embodiments of the present disclosure when configured accordingly.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor to perform the algorithms and/or operations described herein when the instructions are executed.

In some embodiments, the memory 204 may be non-transitory and may include, for example, one or more volatile and/or non-volatile memories. In other words, for example, the memory 204 may be an electronic storage device (e.g., a computer readable storage medium). The memory 204 may be configured to store information, data, content, applications, instructions, or the like, for enabling the access permission elevation computing device 106 to carry out various functions in accordance with example embodiments of the present disclosure. In this regard, the memory 204 may be preconfigured to include computer-coded instructions (e.g., computer program code), and/or dynamically be configured to store such computer-coded instructions for execution by the processor 202.

In an example embodiment, the access permission elevation computing device 106 further includes a communications circuitry 206 that may enable the access permission elevation computing device 106 to transmit data and/or information to other devices or systems through a network (such as, but not limited to, the camera(s) 108 and the data store 110 as shown in FIG. 1). The communications circuitry 206 may be any means such as a device or circuitry embodied in either hardware or a combination of hardware and software that is configured to receive and/or transmit data from/to a network and/or any other device, circuitry, or module in communication with the access permission elevation computing device 106. In this regard, the communications circuitry 206 may include, for example, a network interface for enabling communications with a wired or wireless communication network. For example, the communications circuitry 206 may include one or more circuitries, network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

In some embodiments, the access permission elevation computing device 106 includes input/output circuitry 208 that may, in turn, be in communication with the processor 202 to provide output to the user and, in some embodiments, to receive an indication of a user input. The input/output circuitry 208 may comprise an interface or the like. In some embodiments, the input/output circuitry 208 may include a keyboard, a mouse, a joystick, a touch screen, touch areas, soft keys, a microphone, a speaker, or other input/output mechanisms. The processor 202 and/or input/output circuitry 208 may be configured to control one or more functions of one or more user interface elements through computer program instructions (e.g., software and/or firmware) stored on a memory accessible to the processor (e.g., memory 204). The processor 202 and/or input/output circuitry 208 may also be configured to control one or more camera(s) 108 integrated by the mobile device access permission elevation system 104.

In some embodiments, the access permission elevation computing device 106 includes the display 210 that may, in turn, be in communication with the processor 202 to display user interfaces (such as, but not limited to, display of a call and/or an application). In some embodiments of the present disclosure, the display 210 may include a liquid crystal display (LCD), a light-emitting diode (LED) display, a plasma (PDP) display, a quantum dot (QLED) display, and/or the like.

In some embodiments, the access permission elevation computing device 106 includes the data storage circuitry 212 which comprises hardware, software, firmware, and/or a combination thereof, that supports functionality for generating, storing, and/or maintaining one or more data objects associated with the mobile device access permission elevation system 104. For example, in some embodiments, the data storage circuitry 212 includes hardware, software, firmware, and/or a combination thereof, that stores data related to image data captured by the camera(s) 108 in the data store 110. Additionally or alternatively, the data storage circuitry 212 also stores and maintains data related to one or more navigational input command sequences in the data store 110. Additionally or alternatively still, the data storage circuitry 212 also stores and maintains training data for a trained machine vision model associated with the mobile device access permission elevation system 104 in the data store 110. In some embodiments, the data storage circuitry 212 can be integrated with, or embodied by, the data store 110. In some embodiments, the data storage circuitry 212 includes a separate processor, specially configured field programmable gate array (FPGA), or a specially programmed application specific integrated circuit (ASIC).

In some embodiments, the access permission elevation computing device 106 includes access permission elevation circuitry 214 which comprises hardware, software, firmware, and/or a combination thereof, that supports functionality for elevating the access permissions of a mobile device(s) 102. In one or more embodiments, the access permission elevation circuitry 214 works in conjunction with the processor 202 and one or more components of the access permission elevation computing device 106 to elevate the access permissions of the mobile device(s) 102. For example, the access permission elevation circuitry 214 in conjunction with the processor 202 and/or the communications circuitry 206 can transmit, to the mobile device(s) 102, signals configured to simulate a connection of one or more peripheral input devices to the mobile device(s) 102. For instance, the access permission elevation circuitry 214 can transmit signals that simulate the presence of a computer keyboard and/or a computer mouse at the USB port of the mobile device(s) 102. In some embodiments, the access permission elevation computing device 106 may perform port mapping and other related functions associated with connecting and transmitting instructions between the computing device and mobile device(s). Once the simulated connection of the peripheral devices has been established with the mobile device(s) 102, the access permission elevation circuitry 214 can determine a sequence of navigational input commands to be executed on the mobile device(s) 102 and, in conjunction with the processor 202 and/or communications circuitry 206, transmit signals to the mobile device(s) 102 configured to transmit signals that simulate the execution of said sequence of navigational input commands from said simulated peripheral device. For example, one or more navigational input commands of the sequence of navigational input commands can be an input command simulating a keyboard entry and/or a mouse click selecting an interface attribute (e.g., interface attribute 408) on an electronic interface (e.g., electronic interface 401) of the mobile device(s) 102.

Additionally, the access permission elevation circuitry 214 can determine if the access permissions associated with the mobile device(s) 102 have been elevated to an administrative level, (e.g., a “debugging mode”), such that the access permission elevation computing device 106 can then direct the processor 202 to cause initiation of one or more software programs on the mobile device(s) 102. In various embodiments, the one or more computer executable instructions to be executed on the mobile device(s) 102 can be directed towards retrieving, altering, and/or removing data stored in the non-transitory memory of the mobile device, diagnosing and/or repairing one or more faults, elevating and/or demoting various access permissions, and/or re-instantiating default factory settings associated with the mobile device(s) 102. In some embodiments, the one or more computer executable instructions to be executed on the mobile device(s) 102 can be stored in the memory 204 and/or the data store 110.

In exemplary embodiments, the access permission elevation computing device 106 includes machine vision model circuitry 218 which comprises hardware, software, firmware, and/or a combination thereof, that supports functionality for creating, training, updating, maintaining, and/or employing a trained machine vision model according to various embodiments of the present disclosure, including for elevating the access permissions associated with the mobile device(s) 102. In various embodiments, the machine vision model circuitry 216 can work in conjunction with the processor 202, the input/output circuitry 208, and/or the access permission elevation circuitry 214. Additionally, in some embodiments, the machine vision model circuitry 216 can control the camera(s) 108 of the mobile device access permission elevation system 104 and/or receive image data, directly or indirectly, created by the camera.

In some embodiments, the machine vision model circuitry 216 can direct the camera(s) 108 to capture image data related to the configuration of one or more interface attributes on the electronic interface of the mobile device(s) 102 (e.g., interface attributes 410-424 configured on electronic interface 401). In one or more embodiments, the one or more interface attributes rendered on the electronic interface can be visual representations of one or more respective mobile device attributes associated with the mobile device(s) 102 including, but not limited to, a mobile device manufacturer, a mobile device model, a mobile device operating system, a mobile device software version, a current access permission level, or a combination thereof. In one or more embodiments, the trained machine vision model may associate one or more interface attributes rendered on the electronic interface with one or more mobile device attributes either implicitly (e.g., by matching an icon shape with a known icon of a particular operating system) or explicitly (e.g., by reading device information text on the device interface). Based on the captured image data, the machine vision model circuitry 216 can determine a navigational state of the mobile device and/or an appropriate sequence of navigational input commands to be executed on the mobile device(s) 102.

In some embodiments, the machine vision model circuitry 216 can direct the camera(s) 108 to capture image data related to a current navigational state—e.g., the current configuration of one or more interface attributes (e.g., interface attributes 410-424) of the electronic interface (e.g., electronic interface 401)—and compare the captured image data to other previously collected image data stored in the data store 110 (e.g., via a machine vision model according to any of the various embodiments discussed herein). In some embodiments, the machine vision model circuitry 216 can execute one or more pre-processing steps on the image data to facilitate input into the model. For instance, the machine vision model circuitry 216 can isolate the electronic interface and/or the mobile device body or a portion of the mobile device body and/or segment the image into regions by, for example, performing one or more edge detection techniques. The machine vision model circuitry 216 can also make one or more rotational adjustments with respect to the image data. Additionally or alternatively, the machine vision model circuitry 216 can apply one or more filters to the image data including, but not limited to, a gaussian blur filter, an inversion filter, color corrections such as a grayscale conversion filter, and/or one or more linear filters. In some embodiments, isolating the mobile device electronic interface (e.g., isolating the screen showing the interface) and applying the one or more filters may enable higher accuracy of OCR and other identification methods when processing the images. The applied filter(s) may depend on factors such as background color, contrast (screen brightness), and language.

In some embodiments, the machine vision model circuitry 216 may be configured to input one or more images of the electronic interface or any portion hereof into the trained machine vision model for analysis. Based on the comparison of the image data, the machine vision model circuitry 216 can determine a next navigational input command to be input on the mobile device(s) 102 in order to elevate the access permissions of the mobile device(s) 102. For example, once the access permission elevation circuitry 214 causes the processor 202 and/or the communications circuitry 206 to transmit signals to the mobile device(s) 102 to execute one or more navigational input commands as being simulated navigational input commands from the simulated peripheral devices.

Furthermore, the machine vision model circuitry 216 can determine if a current navigational state is a correct navigational state relative to the navigational input commands that have been executed on the mobile device(s) 102 (e.g., by comparing an identified navigational state with an expected navigational state) and/or otherwise identify the current navigational state. Based on the captured image data related to the configuration of interface attributes on the electronic interface of the mobile device(s) 102, the machine vision model circuitry 216 can determine if the mobile device(s) 102 has navigated to the correct location within its corresponding mobile device menu hierarchy. As such, the machine vision model circuitry 216 can determine whether the sequence of navigational commands generated based on the mobile device attributes associated with the mobile device(s) 102 is on track, aka being on a “happy-path,” to successfully elevate the access permissions of the mobile device(s) 102. In various embodiments, the machine vision model circuitry 216 can check the current status of the access permission level of the mobile device(s) 102 at any point during the sequence of navigational input commands.

Similarly, once the sequence of navigational input commands has been fully executed, the machine vision model circuitry 216 can determine whether the access permissions of the mobile device(s) 102 have been elevated. For example, the machine vision model circuitry 216 can determine that the access permissions of the mobile device(s) 102 have been elevated based information comprised in one or more one or more interface attributes (e.g., interface attributes 410-424) rendered on the electronic interface (e.g., electronic interface 401) of the mobile device(s) 102. Additionally or alternatively, in certain embodiments, the mobile device access permission elevation system 104 can programmatically determine whether the access permissions of the mobile device(s) 102 have been elevated. For instance, the processor 202 can execute one or more portions of computer program code (e.g., stored in the memory 204) that determine the current level of access of the mobile device(s) 102. For example, the access permission elevation system 104 may attempt to open a bridge to the mobile device and/or load software (e.g., apps) onto the mobile device to confirm access permissions (e.g., to confirm entry into a debug mode). In response to determining that the access permissions of the mobile device(s) 102 have indeed been elevated, the machine vision model circuitry 216 can direct the processor 202 to cause execution of one or more computer executable instructions on the mobile device(s) 102.

In some embodiments, two or more of the sets of circuitries 202-216 are combinable. Additionally or alternatively, in some embodiments, one or more of the sets of circuitry perform some or all of the functionality described associated with another component. For example, in some embodiments, two or more of the sets of circuitries 202-216 are combined into a single module embodied in hardware, software, firmware, and/or a combination thereof. Similarly, in some embodiments, one or more of the sets of circuitries, for example the communications circuitry 206, the data storage circuitry 212, and/or the access permission elevation circuitry 214 is/are combined with the processor 202, such that the processor 202 performs one or more of the operations described above with respect to each of these sets of circuitries 206 and 214-216.

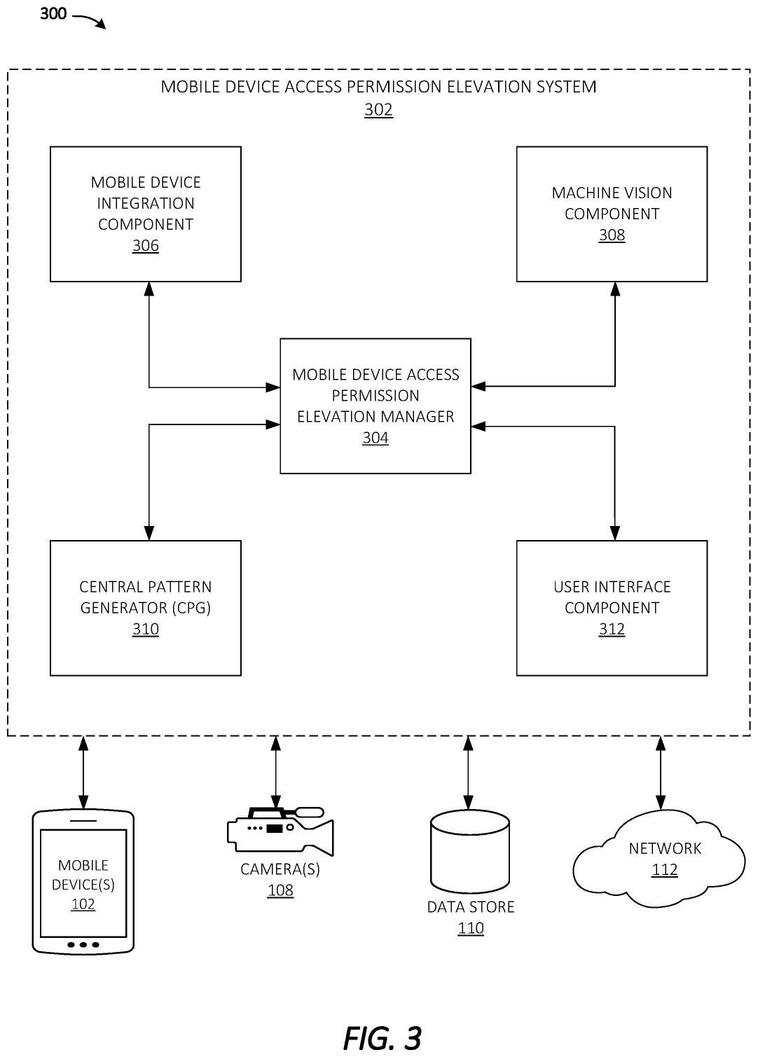

FIG. 3 is a block diagram illustrating various data flows between components of a mobile device access permission elevation system illustrating a system architecture in an exemplary environment 300 configured for automatically elevating access permissions in a mobile device in accordance with one or more embodiments of the present disclosure. For example, the depicted exemplary environment 300 includes a mobile device access permission elevation system 302 capable of directly interfacing with one or more mobile device(s) 102, data store 110, network 112, and/or camera(s) 108. The mobile device access permission elevation system 302 comprises a mobile device access permission elevation manager 304, a mobile device integration component 306, a machine vision component 308, a central pattern generator (CPG) 310, and a user interface component 312.

In various embodiments, the components 304-312 of the mobile device access permission elevation system 302 can be configured as one or more portions of executable code. In one or more embodiments, the mobile device access permission elevation system 302 can be integrated with, or embodied by, one or more computing devices (e.g., computing device(s) 106). Although the components 304-312 are described with respect to functional limitations, it should be understood that the particular implementations necessarily include the use of particular computing hardware. For example, the components 304-312 may work in conjunction with the various circuitries of a computing device (e.g., circuitries 202-216 of the access permission elevation computing device 106).

For instance, in some embodiments, one or more of the components 304-312 of the mobile device access permission elevation system 302 can include, or be integrated with, processor 202 of access permission elevation computing device 106 to execute various operations. Additionally or alternatively, the components 304-312 can include, or be integrated with, a separate respective processor, specially configured field programmable gate array (FPGA), or a specially programmed application specific integrated circuit (ASIC). As another example, in various embodiments, one or more of the components 304-312 of the mobile device access permission elevation system 302 can also include, or be integrated with, the memory 204 and/or data storage circuitry 212 of the access permission elevation computing device 106. Additionally or alternatively, in other various embodiments, one or more of the components 304-312 of the mobile device access permission elevation system 302 can include, or be integrated with, separate respective non-transitory memory devices configured to store one or more portions of respective executable code configured to execute various respective operations associated with the components 304-312.

The mobile device access permission elevation system 302 includes a mobile device access permission elevation manager 304. In various embodiments, the mobile device access permission elevation manager 304 comprises logic responsible for directing the components 306-312 of the mobile device access permission elevation system 302 to execute various operations related to elevating the access permissions of one or more respective mobile devices (e.g., mobile device(s) 102). For example, the mobile device integration component 306 can detect when a new mobile device (e.g., mobile device(s) 102) is connected (e.g., via a USB connection) to the mobile device access permission elevation system 302, and, once the connection is established, the mobile device access permission elevation manager 304 can direct the mobile device integration component 306 to retrieve information from the mobile device (e.g., make, model, and/or any other information exposed by the mobile device). In some embodiments, the mobile device access permission elevation manager 304 can map the ports associated with the one or more mobile device(s) 102 connected to the mobile device access permission elevation system 302 to ensure that the correct simulated navigational input commands are being executed on the correct mobile device(s) 102. The mapping of the ports of the one or more mobile device(s) 102 may also ensure that any operations executed by the various components 306-312 of the mobile device access permission elevation system 302 are being executed on the correct respective mobile device(s) 102 (e.g., in an instance in which multiple mobile devices are connected to the system).

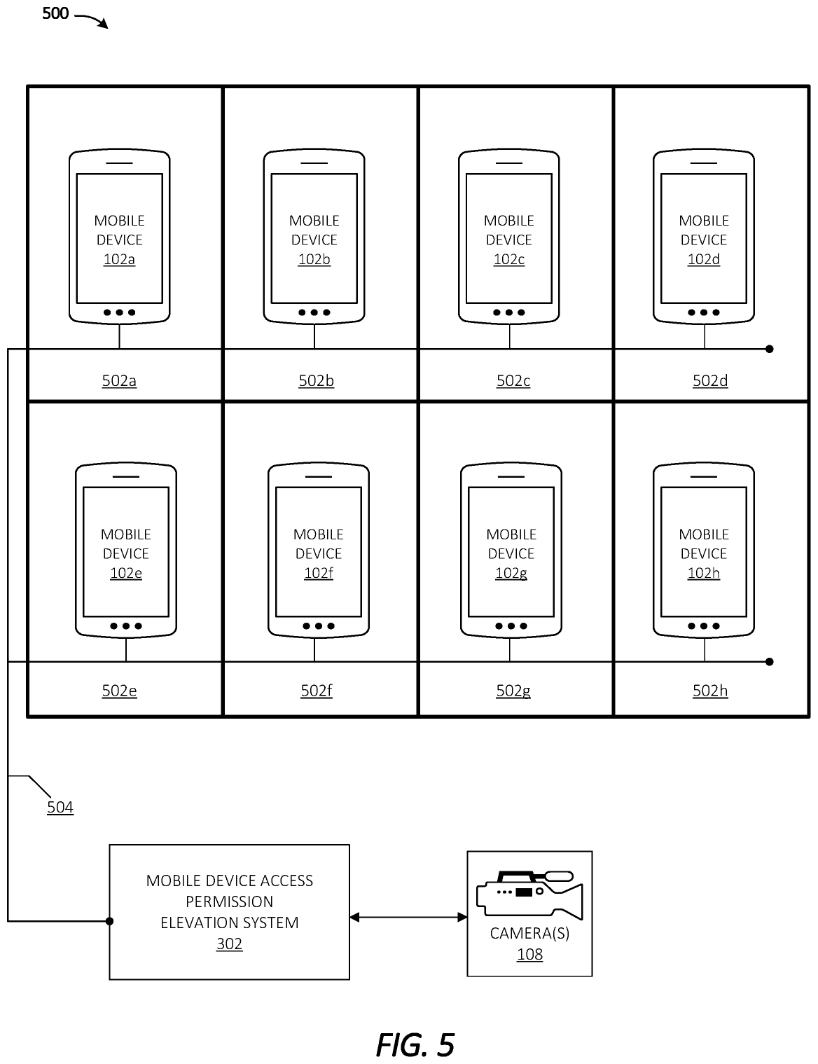

In the depicted example embodiment, the mobile device integration component 306 is responsible for establishing a serial connection to the one or more mobile device(s) 102 connected to the mobile device access permission elevation system 302. In some embodiments, the mobile device integration component 306 can establish the serial connection to the one or more mobile device(s) 102 via a wired USB connection (e.g., via wired USB bus 504 shown in FIG. 5). Once a successful connection has been made to the one or more mobile device(s) 102, the mobile device integration component 306 can send and receive signals to and from the one or more mobile device(s) 102. Upon a successful connection, the mobile device integration component 306 may retrieve metadata related to the mobile device(s) 102, if available, which metadata may correspond to, but is not limited to, the make, model, operating system, firmware version, carrier information, and/or other identifying information associated with the mobile device(s) 102. Once the mobile device integration component 306 has retrieved the metadata associated the mobile device(s) 102, the mobile device integration component 306 can then transmit said metadata to the mobile device access permission elevation manager 304 for subsequent usage.

In the depicted embodiment, the mobile device integration component 306 is also responsible for simulating the presence of one or more peripheral input devices at the respective USB ports of the mobile device(s) 102. In some embodiments, the mobile device integration component 306 can simulate various peripheral devices associated with a human interface device (HID) protocol (e.g., a computer keyboard and/or computer mouse) and register the simulated HID peripheral devices with the mobile device(s) 102. Once the simulated HID peripheral devices have been successfully registered with the mobile device(s) 102, the mobile device access permission elevation manager 304 can direct the mobile device integration component 306 to transmit HID documents representing various keyboard and/or mouse input commands to the one or more mobile device(s) such that the mobile device access permission elevation manager 304 can control the mobile device(s) 102.

The machine vision component 308 of the mobile device access permission elevation system 302 is configured to provide feedback (e.g., whether such feedback is constant, intermittent, triggered, or the like) related to the current navigational states associated with the respective one or more mobile device(s) 102 connected to the mobile device access permission elevation system 302. The machine vision component 308 is configured to communicate with one or more cameras (e.g., camera(s) 108) to capture and process image data related to the one or more mobile device(s) 102 simultaneously throughout the entire respective access permission elevation processes for each of the mobile device(s) 102 or portions thereof. For example, in some embodiments, multiple mobile devices 102 may be disposed within the field of view of one or more cameras and may be imaged and independently monitored by the mobile device access permission elevation system. In some embodiments, the one or more mobile device(s) 102 can be arranged into various regions of interest (ROIs) within the camera field(s) of view and/or image data, such that the machine vision component 308 can process the captured image data related to each respective ROI.

For example, FIG. 5 illustrates an exemplary environment 500 in which one or more mobile device(s) 102a-102h can be arranged into a grid of respective ROIs 502a-502h and connected to the mobile device access permission elevation system 302 via a wired USB bus 504. In one or more embodiments, the machine vision component 308, in conjunction with the camera(s) 108, is capable of capturing up to one image data frame per fifteen milliseconds associated with the various ROIs 502a-502h and can process the captured image data to determine the respective navigational states of the respective mobile device(s) 102a-102h. In some embodiments, the image data captured of the ROIs 502a-502h comprising the mobile device(s) 102a-102h is “rotationally agnostic.” For example, the machine vision component 308 can successfully process image data related to the mobile device(s) 102 even if the mobile device(s) 102 aren't situated evenly within the respective ROIs 502a-502h and/or image data related to the mobile device(s) 102 is captured from different perspectives relative to the field of view of the camera(s) 108. In some embodiments, further processing of the image data may be performed prior to analyzing the content of the electronic interface (e.g., before analyzing the respective navigational states). Such processing steps may include, but are not limited to, cropping the ROIs to include only the mobile device and/or only the electronic interfaces of the mobile device; rotating each image portion of each ROI to a predetermined orientation of the mobile device; adjusting contrast, sharpness, brightness, and/or any other image property; color correction and/or grey scaling; and/or the like. While FIG. 5 depicts ROIs 502a-502h comprising mobile device(s) 102a-102h, it will be appreciated that the mobile device access permission elevation system 302 can process more (and/or fewer) mobile device(s) 102 simultaneously than is illustrated in FIG. 5.

In various embodiments, the machine vision component 308 comprises executable code related to employing various machine vision models and/or image processing operations. For instance, in one or more embodiments, known machine vision libraries and applications such as OpenCV can be employed to capture and analyze image data associated with the mobile device(s) 102a-102h contained within the respective ROIs 502a-502h. Additionally and/or alternatively, the mobile device access permission elevation system 302 can employ captured image data as a training data set to develop one or more machine vision models directed towards elevating the access permission of a mobile device (e.g., mobile device 102). Some embodiments can also employ optical character recognition (OCR) during image processing in order to determine the current navigational state of one or more mobile device(s) 102. For example, the machine vision component 308 may capture image data related to a navigational state such as the one depicted on electronic interface 401 of mobile device 102 in FIG. 4B. The machine vision component 308 can employ OCR techniques on the captured image data to determine information about the mobile device 102, such as the manufacturer and model name as rendered by interface attributes 412 and 414 respectively on the electronic interface 401 of the mobile device 102.

The machine vision component 308 can employ various image recognition and/or pattern recognition techniques while parsing image data captured by the camera(s) 108. For instance, in various embodiments, the machine vision component 308 can be configured to search for common application icons rendered on the electronic interface of a mobile device (e.g., interface attributes 402-408 rendered on electronic interface 401 of mobile device 102). Likewise, in various embodiments, the machine vision component 308 can be configured to search for one or more types of interface attributes rendered on an electronic interface of a mobile device (e.g., interface attribute 424 rendered as an interactive button on electronic interface 401).

Based on the various interface attributes and/or the navigational state rendered on an electronic interface 401 (illustrated in FIGS. 4A-4B) of a particular mobile device 102 and detected by the machine vision component 308, the mobile device access permission elevation manager 304 can direct the mobile device integration component 306 to transmit various signals to simulate the peripheral navigational input commands to the respective mobile device 102. For example, in some embodiments, the mobile device access permission elevation manager 304 may direct the mobile device integration component 306 to transmit a navigational input command comprising a simulated keyboard input for selecting a particular interface attribute (e.g., interface attribute 408) based on image data captured by the machine vision component 308.

Furthermore, the machine vision component 308 can determine one or more filters to apply to any image data that has been captured to better parse the data rendered by various interface attributes (e.g., interface attributes 410-424). For example, the machine vision component 308 can determine that certain data comprised within the captured image data related to a particular mobile device 102 can be better interpreted if the image is converted into a greyscale coloring format instead of a full-color format. The machine vision component 308 can also determine if a certain image file comprising captured image data could be better managed once converted into a different file type. For example, in some embodiments, the image data captured by the machine vision component 308 may be initially stored as a .jpeg file type and later converted into a bitmap file type that might be easier to employ during a mobile device access permission elevation process. In some embodiments, the machine vision component 308 may comprise one or more predetermined filters and/or other processes that are applied to all or a subset of the image data.

The central pattern generator (CPG) 310 of the mobile device access permission elevation system 302 can determine a sequence of navigational input commands directed toward elevating the access permissions of one or more particular mobile device(s) 102. For example, once the mobile device integration component 306 retrieves or otherwise determines the metadata comprising relevant identifying information associated with the one or more mobile device(s) 102, the mobile device integration component 306 can transmit the metadata to the mobile device access permission elevation manager 304. In response to receiving the metadata comprising the identifying information associated with the one or more mobile device(s) 102, the mobile device access permission elevation manager 304 can direct the CPG 310 to determine a relevant sequence of navigational input commands based on the metadata associated with the one or more mobile device(s) 102. In various embodiments, the CPG 310 works in conjunction with a data store (e.g., data store 110) comprising sequences of navigational input commands associated with respective particular mobile devices. For instance, the data store 110 can comprise sequences of navigational input commands associated with specific types of mobile devices employing specific operating systems and/or specific versions of firmware. For example, the data store 110 may comprise numerous sequences of navigational input commands associated with various particular Samsung® mobile devices (e.g., a Samsung® Galaxy S10 mobile phone) running various versions of firmware such that each respective sequence of navigational input commands is configured for a particular mobile device running a particular firmware version. In various embodiments, the CPG 310 can be cloud-based and can fetch relevant sequences of navigational input commands via the network 112 that is integrated with the mobile device access permission elevation system 302.

It will be appreciated that there can be many software differences even for the same make and model of mobile device (e.g., differences across different firmware versions, carriers, operating system versions, etc.). This can be due to carrier influence and/or preferences, updates in software menu layouts and/or security, and many other factors. As such, each sequence of navigational input commands may directly suit the mobile device, operating system, and firmware version of the respective mobile device(s) 102 being processed by the mobile device access permission elevation system 302. Once the CPG 310 has determined a relevant sequence of navigational input commands based on the metadata associated with the one or more mobile device(s) 102 connected to the mobile device access permission elevation system 302, the CPG 310 transmits the sequence of navigational input commands to the mobile device access permission elevation manager 304 for future usage in the access permission elevation procedure.

In various embodiments, the CPG 310 can be configured to determine a unique sequence of navigational input commands that directly suit the mobile device, operating system, and firmware version of the respective mobile device(s) 102 by employing one or more reinforcement learning (RL) techniques. For example, the CPG 310 can embody, or integrate with, an RL model configured to determine and/or improve each navigational input command of the sequence of navigational input commands required to elevate the access permissions of a particular mobile device 102. In order to train the RL model to accurately determine an efficient sequence of navigational input commands for the particular mobile device 102, a list comprising every possible navigational input command (e.g., keyboard command inputs) can be provided to the RL model. The RL model is then instructed to perform a sequence of operations based on the provided list, where the sequence of operations is directed toward reaching a predetermined end condition such as, for example, reaching a navigational state in which the access permissions of the particular mobile device 102 can be elevated.

In certain embodiments, the RL model can employ a cost function algorithm to determine the optimal sequence of navigational input commands associated with the particular mobile device 102. For example, if the RL model is successful at reaching the predetermined end condition, a “reward” is issued to the RL model, the sequence of operations is stored as a potential navigational input command sequence for the particular mobile device 102, and the process is repeated. The RL model is instructed to execute the process of executing various sequences of operations directed towards reaching the predetermined end condition repeatedly, and the RL model is incentivized with additional “bonus rewards” if the RL model executes a sequence of operations that reaches the predetermined end condition in a duration of time that is smaller (e.g., reaches the predetermined end condition faster) than the first successful sequence of operations. In this way, the RL model can determine the most efficient and/or fastest sequence of navigational input commands for elevating the access permissions associated with the particular mobile device 102.

In some embodiments, once the mobile device access permission elevation manager 304 receives a sequence of navigational input commands associated with a particular mobile device 102, the mobile device access permission elevation manager 304 can determine the current navigational state associated with the particular mobile device 102 based on image data captured by the machine vision component 308. Based on the image data captured by the machine vision component 308, the mobile device access permission elevation manager 304 can determine which navigational input command in the sequence of navigational input commands to execute on the particular mobile device 102 (e.g., which command corresponds to the current screen). It will be appreciated that the one or more mobile device(s) 102 connected to the mobile device access permission elevation system 302 can arrive at an exemplary mobile device processing environment (e.g., environment 500) in various navigational states, and that the mobile device access permission elevation manager 304 may determine an initial navigational state of the respective mobile device(s) 102 before executing a sequence of navigational input commands. For example, if a sequence of navigational input commands for a particular mobile device 102 has a total of ten navigational input command “steps,” the mobile device access permission elevation manager 304 may determine that the initial navigational state of the particular mobile device 102 is equivalent to being at the third step of the sequence, and therefore will begin executing navigational input commands from the fourth step onwards rather than executing the sequence of navigational input commands from the first step. In some embodiments, the system may assume, without detecting, a starting state of the mobile device (e.g., assuming the home screen is shown following a new power up) and/or issue a first navigational input command that is agnostic to the current navigational state (e.g., simulating a “home” button press).

In some embodiments, the mobile device access permission elevation manager 304 can determine when a mobile device 102 has entered into an incorrect navigational state relative to an expected happy-path navigational state associated with a particular navigational input command, for example, by comparing a current navigational state to an expected navigational state associated with one or more of the navigational input commands. The expected navigational states may be stored in, for example, the data store 110. In some embodiments, a machine learning model may be trained for each navigational state, and the expected navigational state may refer to the selection of the model associated with the expected navigational state for reviewing the image data (e.g., a “match” determined by the model when applied to the image data confirms the “happy path”). In some embodiments, the mobile device access permission elevation system 302 may check the navigational state following the input of a plurality of simulated navigational input commands (e.g., checking after several inputs or at the end of a predetermined sequence). In some embodiments in which the current navigational state and the expected navigational state do not match, the mobile device access permission elevation manager 304 may present an error so as to alert a human operator associated with the mobile device access permission elevation system 302. In various embodiments the error generated by the mobile device access permission elevation manager 304 can take different forms such as, but not limited to, transmitting a notification for display on the user interface component 312, printing an error log to a command-line console of an associated computing device (e.g., access permission elevation computing device 106), indicating an error has occurred by illuminating an LED indicator associated with an ROI related to the mobile device 102, and/or otherwise broadcasting an alert to a responsible party associated with the mobile device access permission elevation manager 304.

In various embodiments, when the mobile device access permission elevation manager 304 determines a mobile device 102 has entered an incorrect navigational state, the mobile device access permission elevation manager 304 will direct the mobile device integration component 306 to execute navigational input commands to revert the steps taken that resulted in the mobile device 102 navigating to the incorrect navigational state. In one or more embodiments, the mobile device access permission elevation manager 304 can work in conjunction with the CPG 310 to determine a series of navigational input commands that will cause the mobile device 102 to return to a previous navigational state. Additionally and/or alternatively, the mobile device access permission elevation manager 304 can work in conjunction with a trained machine vision model associated with the machine vision component 308 to cause the mobile device 102 to navigate back to a happy-path navigational state. In such embodiments, the machine vision component 308 can determine navigational input commands based on image data captured by the camera(s) 108. For example, based on the captured image data associated with a mobile device 102 that has reached an incorrect navigational state, the machine vision component 308 may identify an interactive interface attribute such as a “back” or “cancel” button in addition to or instead of recognizing the navigational state itself. In this example, the mobile device access permission elevation manager 304 could then direct the mobile device integration component 306 to execute a simulated navigational input command incorporating the identified interactive interface attributes (e.g., such as a simulated mouse or keyboard click on a “back” button identified by the machine vision component 308). This automated process of self-correction by the mobile device access permission elevation system 302 provides the technical benefit of saving the man-hours necessary to troubleshoot individual mobile device(s) 102.

In some embodiments, once the mobile device access permission elevation manager 304 determines that the access permissions associated with a particular mobile device 102 have been successfully elevated, the mobile device access permission elevation manager 304 can open an Android debug bridge (ADB) with the particular mobile device 102. Once the mobile device access permission elevation manager 304 has established the ADB, the mobile device access permission elevation manager 304 can execute one or more commands, operations, and/or one or more computer executable instructions on the particular mobile device 102. In various embodiments, the one or more computer executable instructions executed on the mobile device 102 are directed towards retrieving, altering, and/or removing data stored in the non-transitory memory of the mobile device, diagnosing and/or repairing one or more faults, elevating and/or demoting various access permissions, and/or re-instantiating default factory settings associated with the mobile device 102.

The mobile device access permission elevation system 302 also comprises a user interface component 312. In some embodiments, the access permissions elevation operations executed by the mobile device access permission elevation system 302 are done automatically and autonomously. In some embodiments, the mobile device access permission elevation system 302 includes the user interface component 312 so that a human operator can observe and, if necessary, intervene in the execution of the access permissions elevation operations. In some embodiments, the user interface component 312 may additionally or alternatively connect to another computing device (e.g., a programmable logic controller) for data capture, verification, process control, and/or any other function. In various embodiments, the user interface component 312 can be integrated with, or embodied by, one or more computing devices (e.g., computing device(s) 106). Information related to the respective progress associated with the elevation of the access permissions of the one or more mobile device(s) 102 connected to the mobile device access permission elevation system 302 can be rendered via the user interface component 312, such as on the display of one or more computing devices (e.g., display(s) 210 of computing device(s) 106).

In various embodiments, the user interface component 312 can render a live feed of the image data related to the mobile device(s) 102a-102h inside the respective ROIs 502a-502h being captured by the camera(s) 108 and display on the display of a computing device (e.g., display 210 of access permission elevation computing device 106). Additionally or alternatively, in various embodiments, the user interface component 312 is configured to cause LED indicators associated with the respective ROIs 502a-502h to illuminate with predetermined colors, timing, intensity, etc. In some embodiments, if the access permissions of a particular mobile device 102 have been elevated successfully and the mobile device 102 has been reformatted back into a default state, an LED indicator associated with the respective ROI containing the particular mobile device 102 may turn green. Likewise, if an error has occurred while attempting to elevate the access permissions of a particular mobile device 102, the LED indictor associated with the respective ROI containing the particular mobile device 102 may turn red. It will be appreciated that various LED indications can be configured to represent various states, conditions, and progressions of the respective mobile device(s) 102 contained within the ROIs associated with a particular mobile device access permission elevation system 302.

FIG. 4A-4B illustrates a plurality of exemplary mobile device(s) 102 depicting various configurations of interface attributes on the respective electronic interfaces of the mobile device(s) 102 in accordance with one or more embodiments of the present disclosure. The mobile device(s) 102 illustrated in FIG. 4A and FIG. 4B comprise an electronic interface 401, as well as a plurality of interface attributes. In various embodiments, an interface attribute can be any renderable data label or control associated with the mobile device(s) 102 including, but not limited to, a text label, an interactive icon, a button, a hyperlink, an image, and/or a custom control. Furthermore, interface attributes rendered on a mobile device(s) 102 can be interactive (e.g., an interactive icon such as interface attribute 408) or non-interactive (e.g., a text label such as interface attribute 412). For instance, FIG. 4A depicts a mobile device(s) 102 that is rendering an application menu on the respective electronic interface 401 comprising interface attributes 402-408. In FIG. 4A, the depicted interface attributes 402-408 are rendered as interactive icons by the mobile device (e.g., a mobile device menu interface). FIG. 4B depicts a mobile device(s) 102 rendering an “About Phone” menu page configured by interface attributes 410-424. In FIG. 4B, the interface attributes are rendered as various text labels (e.g., interface attributes 410-418), hyperlinks (e.g., interface attributes 420-422), and buttons (e.g., interface attribute 424). In some embodiments, the interface of FIG. 4B can be accessed via the settings menu (e.g., depicted by interface attribute 408) illustrated in FIG. 4A, either directly or via one or more intermediate menus.

In one or more embodiments, the interface attributes rendered on the electronic interface 401 are visual representations of one or more mobile device attributes associated with the mobile device(s) 102. The one or more mobile device attributes can include data related to, but not limited to, a mobile device manufacturer, a mobile device model, a mobile device operating system, a mobile device software version, a current access permission level, and/or a combination thereof. For example, interface attributes 412 and 414 are visual representations of mobile device attributes related to the respective manufacturer and model name of the mobile device(s) 102. Similarly, interface attributes 416 and 418 are visual representations of mobile devices attributes related to the respective model number and operating system associated with the mobile device(s) 102.

A particular configuration of interface attributes (e.g., interface attributes 410-424) on the electronic interface 401 of the mobile device(s) 102, whether graphical or text based or a combination thereof, is discussed herein as a navigational state. In various embodiments, a navigational state represents a current “location” within a mobile device menu hierarchy associated with the mobile device(s) 102. The mobile device menu hierarchy is the electronically managed organizational data structure of the mobile device(s) 102 and is a representation of a plurality of locations (e.g., all locations or a subset thereof) within the software of the mobile device comprised within the mobile device(s) 102, which may include applications menus, file menus, settings menus, and/or the like. In various embodiments, the mobile device menu hierarchy may comprise interactive menus and sub-menus related to the various configuration parameters associated with the mobile device(s) 102 such that a mobile device access permission elevation system 104 may navigate through said menus and sub-menus in order to update the configurations and access permissions related to the mobile device(s) 102. Each location (e.g., level, sub-level, and/or node) within the mobile device menu hierarchy is associated with a specific configuration of interface attributes, or navigational states, associated with the mobile device(s) 102. In various embodiments, the mobile device menu hierarchy and the respective navigational states are unique to a particular manufacturer, model, and/or cellular service provider of a particular mobile device(s) 102. As discussed herein, the machine vision component 308 may be configured to identify the current navigational state based upon the image data captured by the camera(s).

As a non-limiting example, FIG. 4B depicts a navigational state associated with the “About Phone” menu in the mobile device menu hierarchy associated with the mobile device(s) 102. In this example, the mobile device access permission elevation system 104 may have transmitted signals to execute simulated navigational input commands on the mobile device(s) 102 such that the mobile device(s) 102 navigated to the particular navigational state depicted in FIG. 4B. For instance, the mobile device access permission elevation system 104 may have transmitted a signal to execute a simulated navigational input command such as a simulated mouse click, keyboard input, and/or simulated finger press on the interface attribute 408 shown in FIG. 4A to cause the mobile device(s) 102 to navigate to a first navigational state representing the “Settings Menu” of the mobile device(s) 102. From there, similar subsequent navigational input commands transmitted from the mobile device access permission elevation system 104 could have caused the mobile device(s) 102 to arrive at a second navigational state representing the “About Phone” menu as illustrated in FIG. 4B.

### Machine Vision Model

In some embodiments, a trained machine vision model associated with a mobile device access permission elevation system (e.g., mobile device access permission elevation system 104) can interpret the configuration and content of the electronic interface 401 of the mobile device(s) 102 (e.g., identifying a navigational state). In one or more embodiments, the trained machine vision model can determine whether an interface attribute rendered on the electronic interface 401 is interactive (such as an interactive icon, a hyperlink, or a button) or non-interactive (such as a text label). For example, the trained machine vision model can interpret the layout of an application menu such as the menu rendered on the electronic interface 401 in FIG. 4A. In various embodiments, the trained machine vision model is able to interpret interactive icon shapes such as a “cogwheel” icon rendered by interface attribute 408 which indicates a shortcut to a settings menu of the mobile device(s) 102.

Likewise, in various embodiments, the trained machine vision model can interpret the content of interface attributes, either alone or in combination. For example, the trained machine vision model can interpret the content of interface attributes 412-418 depicted in FIG. 4B to determine relevant information about the manufacturer, model, and operating system of the mobile device(s) 102 (e.g., via optical character recognition (OCR) of the text on the electronic interface as captured in image data). Furthermore, the trained machine vision model can interpret one or more interface attributes to determine relevant information related to elevating the access permissions of the mobile device(s) 102. For example, the trained machine vision model can interpret that the interface attribute 424 contains the text “Developer Options” and is also an interactive button; and, as such, may provide a logical way forward in elevating the access permissions of the mobile device(s) 102. In some embodiments, the mobile device access permission elevation system 302 may detect a navigational state based on the image data as a whole or a portion thereof. The identified navigational state may then trigger a predetermined navigational input command (e.g., selecting “Developer Options”) without requiring, although not prohibiting, separate identification of the “Developer Options” button and/or the interactivity thereof.

In some embodiments, the mobile device access permission elevation system 104 can determine a sequence of navigational input commands based on image data captured by the corresponding trained machine vision model. For instance, the mobile device access permission elevation system 104 can determine a sequence of navigational input commands based on captured image data associated with the interface attributes (e.g., interface attributes 412-418) configured on the electronic interface 401 of the mobile device(s) 102. In various embodiments, the trained machine vision model can determine the manufacturer, model, operating system, and the like based on the captured image data comprising interface attributes (e.g., interface attributes 412-418) and determine a particular sequence of navigational input commands for the mobile device access permission elevation system 104 to execute on the mobile device(s) 102. In some embodiments, information not directly related to the current navigational state may additionally or alternatively be determined via other means (e.g., data received via USB connection). In various embodiments, one or more sequences of navigational input commands associated with one or more respective mobile devices can be stored in the data store 110 such that when a particular type of mobile device of the one or more respective mobile devices is identified by the trained machine vision model and/or other means, the correct sequence of navigational input commands can be executed on the particular type of mobile device.

As described herein below in greater detail, the trained machine vision model can capture, via the camera(s) 108 integrated with the mobile device access permission elevation system 104, image data related to the various configurations of the electronic interface 401 of the mobile device(s) 102 during each step in a sequence of navigational input commands being executed on the mobile device(s) 102 and cause the image data to be stored in the data store 110. Said differently, the trained machine vision model can capture image data associated with the respective navigational states that the mobile device(s) 102 navigates to during the sequence of simulated navigational input commands that it executes and associate those navigational states with the corresponding navigational input command that was executed to place the mobile device(s) 102 in that particular navigational state. In various embodiments, the trained machine vision model can compare the captured image data related to the respective navigational states to other previously collected image data stored in the data store 110. In some embodiments, each step of the navigational input commands may be, but is not required to be, captured by the camera(s). In some embodiments, periodic image data may be captured by the camera(s) following some but not all of the navigational input commands (e.g., checkpoints). In some embodiments, image data may only be captured at predetermined instances for which the mobile device access permission elevation system 302 is configured to check the navigational state to verify the current navigational state and/or the efficacy of any previously input navigational input commands.

In one or more embodiments, the data related to one or more sequences of navigational input commands and/or the image data captured during the execution of said one or more sequences of navigational input commands can be utilized by the mobile device access permission elevation system 104 to iteratively train and refine the machine vision model such that the accuracy and efficiency of the machine vision model can be consistently improved. In various embodiments, the data comprised in the data store 110 can be used to train new machine vision models. Additionally and/or alternatively, a mobile device access permission elevation system 104 can employ reinforcement learning (RL) techniques to train a machine vision model (e.g., such as by applying the RL techniques described above with reference to the CPG 310). In such embodiments, the mobile device access permission elevation system 104 can provide simulated peripheral inputs to the machine vision model and then employ a cost function algorithm to incentivize the machine vision model to create patterns and navigational input command sequences for elevating the access permissions associated with various mobile device(s) 102. The camera(s) 108 can be employed to provide constant feedback and confirmation so as to “reinforce” the training of the machine vision model by confirming if an expected result (e.g., navigation to a particular screen and/or execution of a particular function) occurs in response to a particular input or whether an unexpected result occurs.

In various embodiments, the trained machine vision model associated with the mobile device access permission elevation system 104 can determine a next navigational input command of a sequence of navigational input commands to be transmitted to the mobile device(s) 102 (e.g., via USB) based on captured image data related to a particular navigational state of the mobile device(s) 102. For example, the trained machine vision model may determine, based on captured image data of an electronic interface (e.g., the electronic interface 401 in FIG. 4B) that the next navigational input command to be executed on the mobile device(s) 102 should be a simulated mouse click or keyboard selection of a button (e.g., interface attribute 424 rendered as a button on the electronic interface 401). As another example, if the trained machine vision model has previously determined that the access permissions of the mobile device(s) 102 have been successfully elevated, the trained machine vision model may determine that the next navigational input command to be executed on the mobile device(s) 102 should be a simulated keyboard stroke combination to engage the interface attribute 422 rendered as a hyperlink labeled “Reset Phone.”

Furthermore, the trained machine vision model can determine if a current navigational state is a correct navigational state relative to the navigational input commands that have been executed on the mobile device(s) 102. Said another way, based on the captured image data related to the configuration of interface attributes on the electronic interface 401 of the mobile device(s) 102, the trained machine vision model can determine if the mobile device(s) 102 has navigated to the correct location within its corresponding mobile device menu hierarchy. As such, the trained machine vision model can determine whether the sequence of navigational commands generated based on the mobile device attributes associated with the mobile device(s) 102 is on track, aka being on a “happy-path,” to successfully elevate the access permissions of the mobile device(s) 102. In various embodiments, the trained machine vision model can check the current status of the access permission level of the mobile device(s) 102 at any point during the sequence of navigational input commands. Similarly, once the sequence of navigational input commands has been fully executed, the trained machine vision model can determine whether the access permissions of the mobile device(s) 102 have been elevated. In response to determining that the access permissions of the mobile device(s) 102 have indeed been elevated, the trained machine vision model can direct the mobile device access permission elevation system 104 to cause initiation of one or more computer executable instructions on the mobile device(s) 102. In some embodiments, the trained machine vision model may be a machine learning model (e.g., a computational neural network), which may be trained to identify navigational states and/or any other outputs of the trained machine vision model. In some embodiments, the model may be trained by using structured learning in which training data with labels (e.g., each electronic interface image labeled with a corresponding navigational state) may be fed into an algorithm to generate a model to recognize the navigational states and/or any other outputs of the trained machine vision model. In some embodiments, the machine learning model may identify the data points determinative of navigational states and/or any other outputs of the trained machine vision model.

### Example Processes of the Disclosure

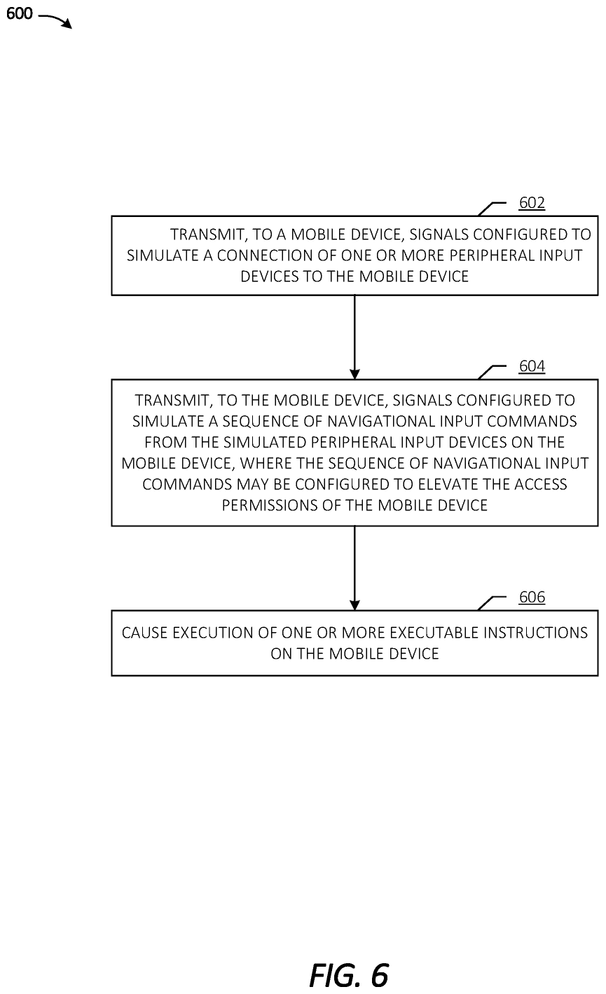

FIG. 6 illustrates a flowchart representing a process 600 for transmitting signals to simulate navigational input commands on a mobile device to elevate access permissions associated with the mobile device in accordance with one or more embodiments of the present disclosure. In some embodiments, the process 600 is embodied by computer program code stored on a non-transitory computer-readable storage medium of a computer program product configured for execution to perform the process as depicted and described. Additionally or alternatively, in some embodiments, the process 600 is performed by one or more specially configured computing devices such as the access permission elevation computing device 106 alone or in communication with one or more other component(s), device(s), and/or system(s) (e.g., the mobile device access permission elevation system 104). In this regard, in some such embodiments, the access permission elevation computing device 106 is specially configured by computer-coded instructions (e.g., computer program instructions) stored thereon, for example in the memory 204 and/or another component depicted and/or described herein and/or otherwise accessible to the access permission elevation computing device 106, for performing the operations as depicted and described. In some embodiments, the access permission elevation computing device 106 is embodied by, or in communication with, one or more external apparatus(es), system(s), device(s), and/or the like, to perform one or more of the operations as depicted and described. For example, the access permission elevation computing device 106 can be in communication with the camera(s) 108, the data store 110, and/or the network 112 integrated with the mobile device access permission elevation system 104. For purposes of simplifying the description, the process 600 is described as performed by and from the perspective of the access permission elevation computing device 106.

The process 600 begins at operation 602. At operation 602, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that transmits, to a mobile device, signals configured to simulate a connection of one or more peripheral input devices to the mobile device. In some embodiments, the access permission elevation computing device 106 of the mobile device access permission elevation system 104 can directly connect (e.g., by a wired USB connection) to a mobile device (e.g., mobile device(s) 102). In various other embodiments, the access permission elevation computing device 106 can connect to the mobile device(s) 102 via other methods such as, but not limited to, near-field communication, Bluetooth, mobile hotspot, Wi-Fi, and/or a wired or wireless LAN connection. Once the access permission elevation computing device 106 is connected to the mobile device(s) 102, the access permission elevation computing device 106 can simulate the connection of one or more peripheral input devices including, but not limited to, computer keyboards, computer mice, microphones, joysticks, touchpads, trackballs, and any other peripheral input devices capable of manipulating the mobile device. For example, the access permission elevation computing device 106 can transmit signals that simulate the presence of a computer keyboard and/or a computer mouse at the USB port of the mobile device(s) 102.

In some embodiments, prior to operation 602, the mobile device may be physically connected (e.g., via USB cable) to the access permission elevation computing device 106 by a user. In some embodiments, the mobile device may be initially locked. In some embodiments, the computing device may be configured to transmit instructions to unlock the device prior to or following the simulated connection of the one or more peripheral input devices (e.g., prior to operation 602 or as part of operation 604).

At operation 604, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that transmits, to the mobile device, signals configured to simulate a sequence of navigational input commands from the simulated peripheral input devices on the mobile device, where the sequence of navigational input commands is configured to elevate the access permissions of the mobile device. For example, once the access permission elevation computing device 106 has successfully simulated the connection of one or more peripheral devices to the mobile device(s) 102, the access permission elevation computing device 106 can transmit signals configured to simulate a sequence of navigational input commands related to the type of simulated peripheral input device type. For example, if the access permission elevation computing device 106 has simulated the connection of a computer keyboard and a computer mouse to the mobile device(s) 102, the simulated sequence of navigational input commands can be one or more of a simulated keyboard stroke, a simulated combination of keyboard strokes, a simulated scroll of the mouse, a simulated click of the mouse, and/or the like.

The sequence of navigational input commands to be simulated on the mobile device(s) 102 can be determined based on image data related to the electronic interface of the mobile device(s) 102 (e.g., electronic interface 401) captured by the camera(s) 108 of the mobile device access permission elevation system 104. The ultimate objective of simulating the sequence of navigational input commands on the mobile device(s) 102 is to elevate the access permissions associated with the mobile device(s) 102 to an administrative level such that one or more computer executable instructions can be executed on the mobile device(s) 102.

At operation 606, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that causes execution of one or more computer executable instructions on the mobile device(s) 102. Once the access permissions associated with the mobile device(s) 102 have been elevated to an administrative level, the access permission elevation computing device 106 can executed one or more computer programs on the mobile device(s) 102. In various embodiments, the one or more computer executable instructions to be executed on the mobile device(s) 102 are directed towards retrieving, altering, and/or removing data stored in the non-transitory memory of the mobile device, diagnosing and/or repairing one or more faults, elevating and/or demoting various access permissions, and/or re-instantiating default factory settings associated with the mobile device(s) 102. In some embodiments, the one or more computer executable instructions to be executed on the mobile device(s) 102 can be stored in the memory 204 and/or the data store 110.

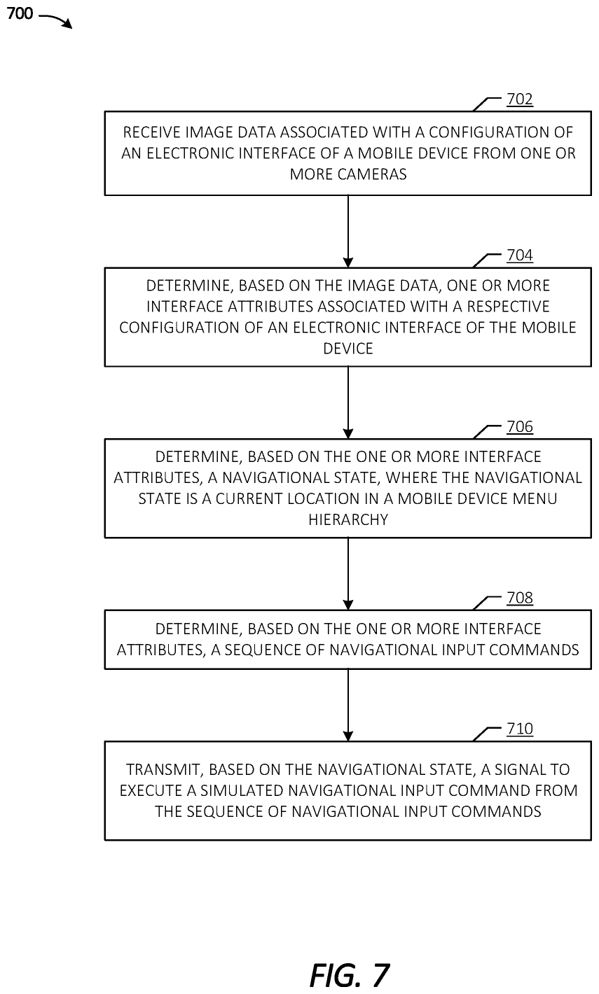

FIG. 7 illustrates a flowchart representing a process 700 for using image data to elevate access permissions in a mobile device in accordance with one or more embodiments of the present disclosure. In some embodiments, the process 700 is embodied by computer program code stored on a non-transitory computer-readable storage medium of a computer program product configured for execution to perform the process as depicted and described. Additionally or alternatively, in some embodiments, the process 700 is performed by one or more specially configured computing devices such as the access permission elevation computing device 106 alone or in communication with one or more other component(s), device(s), and/or system(s) (e.g., the mobile device access permission elevation system 104). In this regard, in some such embodiments, the access permission elevation computing device 106 is specially configured by computer-coded instructions (e.g., computer program instructions) stored thereon, for example in the memory 204 and/or another component depicted and/or described herein and/or otherwise accessible to the access permission elevation computing device 106, for performing the operations as depicted and described. In some embodiments, the access permission elevation computing device 106 is embodied by, or in communication with, one or more external apparatus(es), system(s), device(s), and/or the like, to perform one or more of the operations as depicted and described. For example, the access permission elevation computing device 106 can be in communication with the camera(s) 108, the data store 110, and/or the network 112 integrated with the mobile device access permission elevation system 104. For purposes of simplifying the description, the process 600 is described as performed by and from the perspective of the access permission elevation computing device 106.

The process 700 begins at operation 702. In some embodiments, the process 700 begins after one or more operations depicted and/or described with respect to any one of the other processes described herein. For example, in some embodiments as depicted, the process 700 begins before execution of operation 602. In this regard, some or all of the process 700 may replace or supplement one or more blocks depicted and/or described with respect to any of the processes described herein. Upon completion of the process 700, the flow of operations may terminate. Additionally or alternatively, as depicted, upon completion of the process 700 in some embodiments, flow may return to one or more operation(s) of another process, such as the operation 602. It will be appreciated that, in some embodiments, the process 700 embodies a sub-process of one or more other process(es) depicted and/or described herein, for example the process 600.

At operation 702, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that receives image data associated with a configuration of an electronic interface of a mobile device from one or more cameras. For example, in some embodiments, the access permission elevation computing device 106 can be configured to receive image data related to the electronic interface 401 of the mobile device(s) 102 captured by one or more camera(s) 108 associated with the mobile device access permission elevation system 104. In various embodiments, the access permission elevation computing device 106 can receive image data from the camera(s) 108 in real time. Alternatively, the access permission elevation computing device 106 can be configured to receive image data that has been captured by the camera(s) 108 and stored in the data store 110.

At operation 704, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that determines, based on the image data, one or more interface attributes associated with a respective configuration of an electronic interface of the mobile device. For example, based on the image data captured by camera(s) 108, the access permission elevation computing device 106 can determine one or more interface attributes configured on an electronic interface of a mobile device (e.g., electronic interface 401 of mobile device(s) 102). Such interface attributes can include, but are not limited to, a text label, an interactive icon, a button, a hyperlink, an image, and/or a custom control. Furthermore, interface attributes rendered on a mobile device(s) 102 can be interactive (e.g., an interactive icon such as interface attribute 408) or non-interactive (e.g., a text label such as interface attribute 412. For example, the electronic interface 401 illustrated in FIG. 4B depicts an “About Phone” menu page configured by interface attributes 410-424. In this example, the interface attributes are rendered as various text labels (e.g., interface attributes 410-418), hyperlinks (e.g., interface attributes 420-422), and buttons (e.g., interface attribute 424). Additionally, the interface attributes rendered on the electronic interface 401 can be visual representations of one or more mobile device attributes associated with the mobile device(s) 102. The one or more mobile device attributes can include data related to, but not limited by, a mobile device manufacturer, a mobile device model, a mobile device operating system, a mobile device software version, a current access permission level, and/or a combination thereof. For example, interface attributes 412 and 414 are visual representations of mobile device attributes related to the respective manufacturer and model name of the mobile device(s) 102.

At operation 706, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that determines, based on the one or more interface attributes, a navigational state, where the navigational state is a current location in a mobile device menu hierarchy. A particular configuration of interface attributes (e.g., interface attributes 410-424) on the electronic interface 401 of the mobile device(s) 102 is known as a “navigational state.” In various embodiments, a navigational state represents a current “location” within a mobile device menu hierarchy associated with the mobile device(s) 102. The mobile device menu hierarchy is the electronically managed organizational data structure of the mobile device(s) 102 and is a representation of all the data, menus, and applications comprised within the mobile device(s) 102. In various embodiments, the mobile device menu hierarchy may comprise interactive menus and sub-menus related to the various configuration parameters associated with the mobile device(s) 102 such that a mobile device access permission elevation system 104 may navigate through said menus and sub-menus in order to update the configurations and access permissions related to the mobile device(s) 102. Each location (e.g., level, sub-level, and/or node) within the mobile device menu hierarchy is associated with a specific configuration of interface attributes, or navigational states, associated with the mobile device(s) 102. In various embodiments, the mobile device menu hierarchy and the respective navigational states are unique to a particular manufacturer, model, and/or cellular service provider of a particular mobile device(s) 102.

For example, FIG. 4B depicts a navigational state associated with the “About Phone” menu in the mobile device menu hierarchy associated with the mobile device(s) 102. In this example, the mobile device access permission elevation system 104 may have transmitted signals to execute simulated navigational input commands on the mobile device(s) 102 such that the mobile device(s) 102 navigated to the particular navigational state depicted in FIG. 4B. For instance, the mobile device access permission elevation system 104 may have transmitted a signal to execute a simulated navigational input command such as a simulated mouse click, simulated keyboard stroke, or simulated finger press on the interface attribute 408 to cause the mobile device(s) 102 to navigate to a first navigational state representing the “Settings Menu” of the mobile device(s) 102. From there, similar subsequent navigational input commands transmitted from the mobile device access permission elevation system 104 could have caused the mobile device(s) 102 to arrive at a second navigational state representing the “About Phone” menu as illustrated in FIG. 4B.

In various embodiments, operations 704 and 706 may be a combined step in which the computing device is configured to determine the navigational state based on the image data (e.g., the computing device may, but is not required to, separately identify “interface attributes” and “navigational states”, and a trained model may be configured to determine the navigational states directly from the image data with or without pre-processing). For example, in various embodiments, the trained model can calculate a degree of confidence that a navigational state has been correctly determined by analyzing the electronic interface 401 of a mobile device 102 as a whole without parsing information comprised in one or more interface attributes (e.g., interface attributes 402-424) displayed on the electronic interface 401. If the degree of confidence related to the navigational state satisfies a predefined threshold, the access permission elevation computing device 106 can proceed to determine and issue a sequence navigational input commands to elevate the access permissions of the mobile device(s) 102. However, if the degree of confidence related to the navigational state does not satisfy the predefined threshold, the access permission elevation computing device 106 can proceed to determine the current navigational state of the mobile device 102 in a procedural manner. For instance, the access permission elevation computing device 106 can parse data from the electronic interface 401 by identifying one or more icons (e.g., interface attributes 402-408) and/or parsing data from interface attributes rendered as various text labels (e.g., interface attributes 410-418), hyperlinks (e.g., interface attributes 420-422), and/or buttons (e.g., interface attribute 424) to determine the current navigational state of the mobile device(s) 102.

At operation 708, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that determines, based on the one or more interface attributes, a sequence of navigational input commands. For example, in some embodiments, the access permission elevation computing device 106 can determine a sequence of navigational input commands based on image data captured by the camera(s) 108. For instance, the access permission elevation computing device 106 can determine a sequence of navigational input commands based on captured image data associated with the interface attributes (e.g., interface attributes 412-418) configured on the electronic interface 401 of the mobile device(s) 102. In various embodiments, the access permission elevation computing device 106 can determine the manufacturer, model, operating system, and the like based on the captured image data comprising interface attributes (e.g., interface attributes 412-418) and determine a particular sequence of navigational input commands to execute on the mobile device(s) 102. In various embodiments, one or more sequences of navigational input commands associated with one or more respective mobile devices can be stored in the data store 110 such that when a particular type of mobile device of the one or more respective mobile devices is identified by the access permission elevation computing device 106, the correct sequence of navigational input commands can be executed on the particular type of mobile device.

At operation 710, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that transmits, based on the navigational state, a signal to execute a simulated navigational input command from a sequence of navigational input commands. In various embodiments, the access permission elevation computing device 106 can determine a navigational input command of a sequence of navigational input commands to be simulated on the mobile device(s) 102 based on captured image data related to a particular navigational state of the mobile device(s) 102. For example, the access permission elevation computing device 106 may determine, based on captured image data of an electronic interface (e.g., the electronic interface 401 in FIG. 4B) that the next navigational input command to be executed on the mobile device(s) 102 should be a simulated mouse click of a button (e.g., interface attribute 424 rendered as a button on the electronic interface 401). As another example, if the access permission elevation computing device 106 has previously determined that the access permissions of the mobile device(s) 102 have been successfully elevated, the access permission elevation computing device 106 may determine that the next navigational input command to be executed on the mobile device(s) 102 should be a simulated keyboard stroke combination to engage an interface attribute that can lead to the reformatting of the mobile device(s) 102 (e.g., the interface attribute 422 rendered as a hyperlink labeled “Reset Phone” on electronic interface 401).

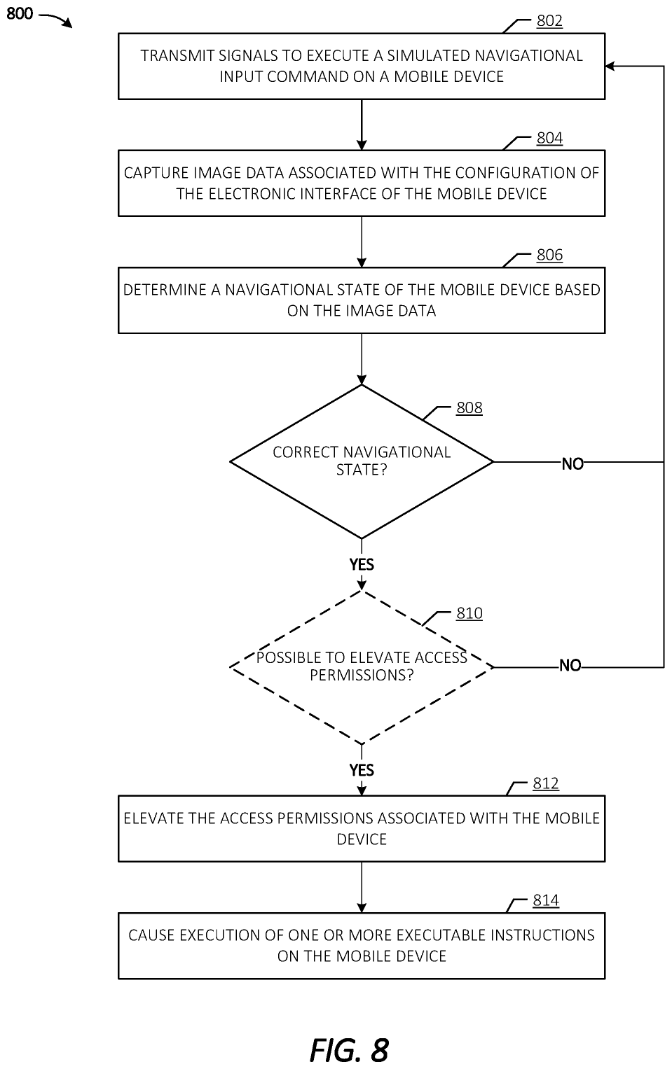

FIG. 8 illustrates a flowchart representing a process 800 for using image data to elevate access permissions and cause execution of one or more computer executable instructions on a mobile device in accordance with one or more embodiments of the present disclosure. In some embodiments, the process 800 is embodied by computer program code stored on a non-transitory computer-readable storage medium of a computer program product configured for execution to perform the process as depicted and described. Additionally or alternatively, in some embodiments, the process 800 is performed by one or more specially configured computing devices such as the access permission elevation computing device 106 alone or in communication with one or more other component(s), device(s), and/or system(s) (e.g., the mobile device access permission elevation system 104). In this regard, in some such embodiments, the access permission elevation computing device 106 is specially configured by computer-coded instructions (e.g., computer program instructions) stored thereon, for example in the memory 204 and/or another component depicted and/or described herein and/or otherwise accessible to the access permission elevation computing device 106, for performing the operations as depicted and described. In some embodiments, the access permission elevation computing device 106 is embodied by, or in communication with, one or more external apparatus(es), system(s), device(s), and/or the like, to perform one or more of the operations as depicted and described. For example, the access permission elevation computing device 106 can be in communication with the camera(s) 108, the data store 110, and/or the network 112 integrated with the mobile device access permission elevation system 104. For purposes of simplifying the description, the process 600 is described as performed by and from the perspective of the access permission elevation computing device 106.

At operation 802, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that transmits signals to execute a simulated navigational input command on a mobile device. In embodiments of the present disclosure, the access permission elevation computing device 106 can transmit, to the mobile device(s) 102, signals configured to simulate a connection of one or more peripheral input devices to the mobile device(s) 102. For instance, the access permission elevation computing device 106 can transmit signals that simulate the presence of a computer keyboard and/or a computer mouse at the USB port of the mobile device(s) 102. Once the simulated connection of the peripheral devices has been established with the mobile device(s) 102, the access permission elevation computing device 106 can determine a sequence of navigational input commands to be executed on the mobile device(s) 102 and transmit signals to the mobile device(s) 102 configured to simulate the execution of the said sequence of navigational input commands. For example, one or more navigational input commands of the sequence of navigational input commands can be an input command simulating a keyboard entry and/or a mouse click selecting an interface attribute (e.g., interface attribute 408) on an electronic interface (e.g., electronic interface 401) of the mobile device(s) 102 in order to access a settings menu. As another example, the access permission elevation computing device 106 may determine that the appropriate navigational input command to be executed on the mobile device(s) 102 should be a simulated keyboard stroke combination to engage an interface attribute that can lead to the reformatting of the mobile device(s) 102 (e.g., the interface attribute 422 rendered as a hyperlink labeled “Reset Phone” on electronic interface 401).

At operation 804, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that captures image data associated with the configuration of the electronic interface of the mobile device. In some embodiments, the access permission elevation computing device 106 can direct the camera(s) 108 to capture image data related to the configuration of one or more interface attributes on the electronic interface of the mobile device(s) 102 (e.g., interface attributes 410-424 configured on electronic interface 401). In one or more embodiments, the one or more interface attributes rendered on the electronic interface can be visual representations of one or more respective mobile device attributes associated with the mobile device(s) 102. The mobile device attributes associated with the mobile device(s) 102 can include, but are not limited to, a mobile device manufacturer, a mobile device model, a mobile device operating system, a mobile device software version, a current access permission level, or a combination thereof. In various embodiments, the image data associated with the configuration of the electronic interface of the mobile device(s) 102 can be video image data captured in real time as the sequence of navigational input commands is executed on the mobile device(s) 102. Alternatively, in some embodiments, the captured image data can be digital photographs comprising the configuration of the electronic interface of the mobile device(s) 102. The access permission elevation computing device 106 can store any image data captured by the camera(s) 108 in the data store 110 for future analysis and/or machine vision model training purposes.

At operation 806, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that determines a navigational state of the mobile device based on the image data. Based on the captured image data, the access permission elevation computing device 106 can determine the current navigational state of the mobile device(s) 102. For example, in one or more embodiments, once the access permission elevation computing device 106 transmits signals to the mobile device(s) 102 to execute one or more simulated navigational input commands, the access permission elevation computing device 106 can direct the camera(s) 108 to capture image data related to a current navigational state—e.g., the current configuration of one or more interface attributes (e.g., interface attributes 410-424) of the electronic interface (e.g., electronic interface 401). As described above, the navigational state of the mobile device(s) 102 can be understood as a current location in a mobile device menu hierarchy associated with the mobile device(s) 102, where the mobile device menu hierarchy is a representation of all the data, menus, and applications comprised within the mobile device(s) 102. The mobile device menu hierarchy may comprise interactive menus and sub-menus related to the various configuration parameters associated with the mobile device(s) 102 such that a mobile device access permission elevation system 104 can navigate through said menus and sub-menus in order to update the configurations and access permissions related to the mobile device(s) 102. As such, each location (e.g., level, sub-level, and/or node) within the mobile device menu hierarchy is associated with a specific navigational state that can be determined by the access permission elevation computing device 106. In various embodiments, the mobile device menu hierarchy and related navigational states are unique to one or more particular makes, models, operating systems, firmware versions, carrier information, and/or other identifying information of a particular mobile device(s) 102.

At operation 808, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that determines whether the mobile device is in a correct, “happy-path” navigational state. For example, the access permission elevation computing device 106 can compare the captured image data related to the current navigational state of the mobile device(s) 102 that was determined in operation 806 to other previously collected image data associated with a similar mobile device stored in the data store 110. In this way, the access permission elevation computing device 106 can determine if a current navigational state is a correct navigational state relative to the navigational input commands that have been executed on the mobile device(s) 102. Said another way, based on the previously captured image data related to a configuration of interface attributes on an electronic interface of a similar mobile device, the access permission elevation computing device 106 can determine if the mobile device(s) 102 has navigated to the correct location within its corresponding mobile device menu hierarchy after executing a particular simulated navigational input command. In some embodiments, the access permission elevation computing device 106 can employ a trained machine vision model to determine whether the sequence of navigational commands is on track, aka being on a “happy-path,” to successfully elevate the access permissions of the mobile device(s) 102 based on the current navigational state.

If the access permission elevation computing device 106 determines that the mobile device(s) 102 has navigated to a correct navigational state, the access permission elevation computing device 106 can proceed to operation 810. However, if the access permission elevation computing device 106 determines that the mobile device(s) 102 has navigated to an incorrect navigational state, the access permission elevation computing device 106 can proceed back to operation 802 and transmit signals to the mobile device(s) 102 to execute another navigational input command in attempt to get back on a “happy-path” forward. In various embodiments, the access permission elevation computing device 106 will direct the mobile device(s) 102 to revert to a prior navigational state before proceeding back to operation 802. The various navigational input commands may be determined from a predetermined menu hierarchy and/or happy path stored in the system, which, based on the detected current navigational state, may permit the system to generate remedial navigational input commands to return to the happy path of the menu hierarchy. In some embodiments, once the mobile device(s) 102 has reverted to the prior navigational state, the access permission elevation computing device 106 may direct the mobile device(s) 102 to execute the same simulated navigational input command that was previously transmitted during the first iteration of operation 802. In alternative embodiments, once the mobile device(s) 102 has reverted to the prior navigational state, the access permission elevation computing device 106 may direct the mobile device(s) 102 to execute an alternative simulated navigational input command than was previously transmitted during the first iteration of operation 802.

In various embodiments, the access permission elevation computing device 106 can be configured to adhere to a predefined navigational failure threshold, where the navigational failure threshold represents a maximum number of attempts the access permission elevation computing device 106 will make to navigate to a correct navigational state before reverting to a specific navigational state previously encountered during the execution of the sequence of navigational input commands. For example, if the access permission elevation computing device 106 determines that it has transmitted signals to the mobile device(s) 102 to revert to the navigational state associated with the first iteration of the operation 802 a certain number of times (e.g., the access permission elevation computing device 106 has transmitted signals to execute the same or alternative navigational input commands from the same navigational state four times), the access permission elevation computing device 106 can transmit signals to the mobile device(s) 102 that cause it to revert to any navigational state previously encountered during the execution of the sequence of navigational input commands. For instance, in some embodiments, the access permission elevation computing device 106 can transmit signals to the mobile device(s) 102 that cause the mobile device(s) 102 to revert to a navigational state that was encountered while executing the second navigational input command of the sequence of navigational input commands. It will be appreciated that in various embodiments of the present disclosure, once the navigational failure threshold has been reached, any number of “steps backward” in the sequence of navigational input commands can be defined such that the process 800 can be re-employed from any navigational state previously encountered while executing the sequence of navigational input commands. In various embodiments, once the access permission elevation computing device 106 determines the navigational failure threshold has been reached, the access permission elevation computing device 106 may transmit signals to the mobile device(s) 102 to revert to a navigational state associated with the “home screen” of the mobile device(s) 102 and determine an alternative sequence of navigational input commands to execute based on the one or more mobile attributes associated with the mobile device(s) 102.

At operation 810, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that determines whether it is possible to elevate access permissions of the mobile device from the current navigational state. If the access permission elevation computing device 106 determines that the mobile device(s) 102 has reached a correct navigational state relative to the execution of a particular navigational input command of the sequence of navigational input commends, the access permission elevation computing device 106 can check whether it is possible to elevate the access permissions associated with the mobile device(s) 102 based on the current navigational state. For instance, the access permission elevation computing device 106 can determine, based on the configuration of one or more interface attributes on the electronic interface of the mobile device(s) 102 (e.g., interface attributes 410-424 configured on electronic interface 401) associated with the current navigational state whether the access permissions associated with the mobile device(s) 102 can be elevated. For example, the access permission elevation computing device 106 may have transmitted signals to the mobile device(s) 102 to execute one or more navigational input commands such that the mobile device(s) 102 reached a navigational state such as the one illustrated in FIG. 4B. The access permission elevation computing device 106 may have determined that this navigational state (e.g., as illustrated in FIG. 4B) is the correct navigational state relative to the navigational input command executed by the mobile device(s) 102 at operation 808, but that is not possible to elevate the access permissions from the current navigational state. In such cases, the access permission elevation computing device 106 can proceed back to operation 802 and transmit signals to the mobile device(s) 102 to execute the next navigational input command in the sequence of navigational input commands. While depicted in FIG. 8 as single operations 808 and 810 for example purposes, the system may be configured to check for a correct navigational state at any point following any navigational input command, and the system may be configured to elevate access permissions as one of the predetermined navigational input commands.

At operation 812, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that elevates the access permissions associated with the mobile device. If the access permission elevation computing device 106 has determined that the access permissions associated with the mobile device(s) 102 can be elevated from the current navigational state, the access permission elevation computing device 106 will proceed to reconfigure the access permissions to place the mobile device(s) 102 into an administrative or “debugging” mode. In doing so, the access permission elevation computing device 106 will be able to transmit signals to the mobile device(s) 102 and execute any number of actions and/or computer executable instructions requiring the highest level of access privileges. In various embodiments, the elevating of the access permissions of the mobile device(s) 102 can be a navigational input command of the sequence of navigational input commands transmitted to the mobile device(s) 102 by the access permission elevation computing device 106. In various other embodiments, the access permission elevation computing device 106 can elevate the access permissions by transmitting signals to the mobile device(s) 102 to execute one or more portions of executable code designed to elevate the access permission level.

At operation 814, the access permission elevation computing device 106 includes means, such as the processor 202, memory 204, communications circuitry 206, input/output circuitry 208, display 210, data storage circuitry 212, access permission elevation circuitry 214, and/or machine vision model circuitry 216, or any combination thereof, that causes the execution of one or more computer executable instructions on the mobile device. In some embodiments, the access permission elevation computing device 106 can determine if the access permissions associated with the mobile device(s) 102 have been elevated to an administrative level such that the access permission elevation computing device 106 can freely cause the execution of one or more computer executable instructions on the mobile device(s) 102. For example, the access permission elevation computing device 106 may be configured to execute a first computer executable instruction to open a communication channel (e.g., an Android Debug Bridge (ADB) for Android phones) following elevation of access permissions, which initial computer executable instruction may confirm the elevation of access permissions, such that the access permission elevation computing device 106 may be configured to execute additional computer executable instructions (e.g., factory resetting the mobile device) on the mobile device. The one or more computer executable instructions to be executed on the mobile device(s) 102 can be directed towards, but are not limited by, retrieving, altering, and/or removing data stored in the non-transitory memory of the mobile device, diagnosing and/or repairing one or more faults, elevating and/or demoting various access permissions, and/or re-instantiating default factory settings associated with the mobile device(s) 102. In some embodiments, the one or more computer executable instructions to be executed on the mobile device(s) 102 can be stored in the memory 204 and/or the data store 110.

The various processes described herein are configured for use in a reverse-logistics environment in which a provider may receive and process tens-of-thousands to millions of mobile devices. Embodiments of the present systems, apparatuses (including devices), computer programs, and methods may be configured to facilitate elevation of access permissions and the associated functionality enabled thereby, including refurbishment, repair, replacement, analysis, and/or any other use case associated with such mobile devices. Embodiments of the present disclosure may facilitate such elevation and subsequent execution of computer executable instructions at each mobile device with little to no user interaction with the mobile device. In some embodiments, the reverse logistics process may comprise receiving a package comprising one or more mobile devices, installing the mobile device(s) in an apparatus comprising a connection to the access permission elevation computing device 106 and various devices, systems, and components described herein, and subsequently performing the elevation process and subsequent processes thereon.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” and similar terms encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software program, software, software application, script, computer executable instructions, computer program code, code, and/or similar terminology) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A computer program can include electronically transmitted computer-executable instructions configured to cause a receiving device to perform one or more functions, including executing one or more pre-programmed functions of the recipient device and/or executing code received from the transmitting device. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

1. An apparatus for elevating access permissions of a mobile device, the apparatus comprising at least one processor and at least one non-transitory memory including computer-coded instructions thereon, the computer coded instructions, with the at least one processor, cause the apparatus to:
transmit, to the mobile device, signals configured to simulate a connection of one or more peripheral input devices to the mobile device;
transmit, to the mobile device, signals configured to simulate a sequence of navigational input commands from the simulated peripheral input devices on the mobile device, wherein the sequence of navigational input commands is configured to elevate the access permissions of the mobile device to an elevated level; and
cause execution of one or more computer executable instructions on the mobile device, wherein the computer executable instructions require the elevated level of the access permissions.

2. The apparatus of claim 1, wherein the apparatus comprises one or more cameras, wherein the computer coded instructions further cause the apparatus to:
receive image data from the one or more cameras;
determine, based on the image data, one or more interface attributes associated with a respective configuration of an electronic interface of the mobile device; and
determine, based on the one or more interface attributes, a navigational state, wherein the navigational state is a current location in a mobile device menu hierarchy.

3. The apparatus of claim 2, wherein the computer coded instructions further cause the apparatus to:
determine, based on the one or more interface attributes, a sequence of navigational input commands; and
transmit, based on the navigational state, a signal to execute a simulated navigational input command from the sequence of navigational input commands.

4. The apparatus of claim 3, wherein the computer coded instructions further cause the apparatus to:
determine, based on the image data, a current state of the access permissions associated with the mobile device.

5. The apparatus of claim 4, wherein the current state of the access permissions associated with the mobile device is determined by a trained machine vision model.

6. The apparatus of claim 3, wherein the computer coded instructions further cause the apparatus to:
capture, in response to transmitting the signal to execute the simulated navigational input command of the sequence of navigational input commands, second image data;
determine, based on the second image data, a second navigational state of the mobile device.

7. The apparatus of claim 6, wherein the computer coded instructions further cause the apparatus to:
determine that the second navigational state is a correct navigational state corresponding to a happy-path navigational state.

8. The apparatus of claim 1, wherein the computer coded instructions further cause the apparatus to:
prior to causing execution of the one or more computer executable instructions on the mobile device, determine whether the access permissions of the mobile device have been elevated.

9. The apparatus of claim 1, wherein the one or more computer executable instructions executed on the mobile device comprise computer coded instructions configured to execute at least one debugging operation of one or more debugging operations, wherein the one or more debugging operations comprise instructions to:
receive device data associated with the mobile device;
diagnose one or more faults with the mobile device;
repair the one or more faults with the mobile device; and
reset the mobile device to a default state.

10. The apparatus of claim 1, wherein the signals configured to simulate a sequence of navigational input commands on the mobile device comprise a plurality of simulated keystrokes, and wherein the signals are transmitted to the mobile device via a cable connected to the mobile device.

11. A computer-implemented method for elevating access permissions of a mobile device via a mobile device access permission elevation system, the method comprising:
transmitting, to the mobile device, signals configured to simulate a connection of one or more peripheral input devices to the mobile device;
transmitting, to the mobile device, signals configured to simulate a sequence of navigational input commands from the simulated peripheral input devices on the mobile device, wherein the sequence of navigational input commands is configured to elevate the access permissions of the mobile device to an elevated level; and
causing execution of one or more computer executable instructions on the mobile device, wherein the computer executable instructions require the elevated level of the access permissions.

12. The computer-implemented method of claim 11, wherein the mobile device access permission elevation system comprises one or more cameras, the computer-implemented method further comprising:
receiving image data from the one or more cameras;
determining, based on the image data, one or more interface attributes associated with a respective configuration of an electronic interface of the mobile device; and
determining, based on the one or more interface attributes, a navigational state, wherein the navigational state is a current location in a mobile device menu hierarchy.

13. The computer-implemented method of claim 12, the computer-implemented method further comprising:
determining, based on the one or more interface attributes, a sequence of navigational input commands; and
transmitting, based on the navigational state, a signal to execute a simulated navigational input command from the sequence of navigational input commands.

14. The computer-implemented method of claim 13, the computer-implemented method further comprising:
determining, based on the image data, a current state of the access permissions associated with the mobile device.

15. The computer-implemented method of claim 14, wherein the current state of the access permissions associated with the mobile device is determined by a trained machine vision model.

16. The computer-implemented method of claim 13, the computer-implemented method further comprising:
capturing, in response to transmitting the signal to execute the simulated navigational input command of the sequence of navigational input commands, second image data;
determining, based on the second image data, a second navigational state of the mobile device.

17. The computer-implemented method of claim 16, the computer-implemented method further comprising:
determining that the second navigational state is a correct navigational state corresponding to a happy-path navigational state.

18. The computer-implemented method of claim 11, the computer-implemented method further comprising:
prior to causing execution of the one or more computer executable instructions on the mobile device, determining whether the access permissions of the mobile device have been elevated.

19. The computer-implemented method of claim 11, wherein the one or more computer executable instructions executed on the mobile device comprise computer coded instructions configured to execute at least one debugging operation of one or more debugging operations, wherein the one or more debugging operations comprise instructions for:
receiving device data associated with the mobile device;
diagnosing one or more faults with the mobile device;
repairing the one or more faults with the mobile device; and
resetting the mobile device to a default state.

20. The computer-implemented method of claim 11, wherein the signals configured to simulate a sequence of navigational input commands on the mobile device comprise a plurality of simulated keystrokes, and wherein the signals are transmitted to the mobile device via a cable connected to the mobile device.

21. A computer program product for elevating access permissions of a mobile device, the computer program product comprising at least one non-transitory computer-readable storage medium having computer program code stored thereon that, in execution with at least one processor, configures the computer program product to:
transmit, to the mobile device, signals configured to simulate a connection of one or more peripheral input devices to the mobile device;
transmit, to the mobile device, signals configured to simulate a sequence of navigational input commands from the simulated peripheral input devices on the mobile device, wherein the sequence of navigational input commands is configured to elevate the access permissions of the mobile device to an elevated level; and
cause execution of one or more computer executable instructions on the mobile device, wherein the computer executable instructions require the elevated level of the access permissions.

22. The computer program product of claim 21, wherein the computer program product comprises one or more cameras, wherein the computer program code further causes the computer program product to:
receive image data from the one or more cameras;
determine, based on the image data, one or more interface attributes associated with a respective configuration of an electronic interface of the mobile device; and
determine, based on the one or more interface attributes, a navigational state, wherein the navigational state is a current location in a mobile device menu hierarchy.

23. The computer program product of claim 22, wherein the computer program code further causes the computer program product to:
determine, based on the one or more interface attributes, a sequence of navigational input commands; and
transmit, based on the navigational state, a signal to execute a simulated navigational input command from the sequence of navigational input commands.

24. The computer program product of claim 23, wherein the computer program code further causes the computer program product to:
determine, based on the image data, a current state of the access permissions associated with the mobile device.

25. The computer program product of claim 24, wherein the current state of the access permissions associated with the mobile device is determined by a trained machine vision model.

26. The computer program product of claim 23, wherein the computer program code further causes the computer program product to:
capture, in response to transmitting the signal to execute the simulated navigational input command of the sequence of navigational input commands, second image data;
determine, based on the second image data, a second navigational state of the mobile device.

27. The computer program product of claim 26, wherein the computer program code further causes the computer program product to:
determine that the second navigational state is a correct navigational state corresponding to a happy-path navigational state.

28. The computer program product of claim 21, wherein the computer program code further causes the computer program product to:
prior to causing execution of the one or more computer executable instructions on the mobile device, determine whether the access permissions of the mobile device have been elevated.

29. The computer program product of claim 21, wherein the one or more computer executable instructions executed on the mobile device comprise computer coded instructions configured to execute at least one debugging operation of one or more debugging operations, wherein the one or more debugging operations comprise instructions to:
receive device data associated with the mobile device;
diagnose one or more faults with the mobile device;
repair the one or more faults with the mobile device; and
reset the mobile device to a default state.

30. The computer program product of claim 21, wherein the signals configured to simulate a sequence of navigational input commands on the mobile device comprise a plurality of simulated keystrokes, and wherein the signals are transmitted to the mobile device via a cable connected to the mobile device.
